(19) United States
(12) Patent Application Publication
(10) Pub. No.: US 2023/0174106 A1
(43) Pub. Date: Jun. 8, 2023

(54) PATH CHECKING DEVICE AND PATH CHECKING METHOD

(71) Applicant: DENSO CORPORATION, Kariya-city (JP)

(72) Inventors: JINGYU XIANG, Nisshin-city (JP); SHUNICHIRO SUGIYAMA, Nisshin-city (JP); HIROYUKI OHSAWA, Kariya-city (JP)

(21) Appl. No.: 18/160,001

(22) Filed: Jan. 26, 2023

Related U.S. Application Data
(63) Continuation of application No. PCT/JP2021/027803, filed on Jul. 27, 2021.

(30) Foreign Application Priority Data
Jul. 29, 2020 (JP) 2020-128559

(51) Int. Cl. B60W 60/00

(52) U.S. Cl. CPC B60W 60/0017; B60W 2554/80; B60W 2554/4041; B60W 2554/4046

(57) ABSTRACT

A path checking device includes: a caution zone setting unit that is configured to, when a moving obstacle is located ahead of a subject vehicle, set a caution zone for the subject vehicle that is located away from the subject vehicle over a safety distance and is between the moving obstacle and the subject vehicle; and a path selection unit that is configured to select, from among generated driving plans, a driving plan along which the subject vehicle will travel such that the moving obstacle does not come in the caution zone for the subject vehicle.

### CROSS REFERENCE TO RELATED APPLICATIONS

This application is a continuation application of International Patent Application No. PCT/JP2021/027803 filed on Jul. 27, 2021, which designated the U.S. and claims the benefit of priority from Japanese Patent Application No. 2020-128559 filed on Jul. 29, 2020. The entire disclosure of all of the above application is incorporated herein by reference.

### TECHNICAL FIELD

The disclosure in this specification relates to a path checking device and a path checking method for controlling travel of a subject vehicle to keep a safety distance.

### BACKGROUND ART

In automated-driving, a safety distance is calculated as a standard for evaluating safety, and a minimum safety distance is maintained between the subject vehicle and other vehicles, pedestrians, or the like.

### SUMMARY

One aspect of the present disclosure is a path checking device for a subject vehicle including a path generation unit that generates a plurality of driving plans for the subject vehicle to travel by automated-driving and a travel control unit that controls traveling of the subject vehicle according to one of the driving plans. The path checking device includes: a safety distance setting unit that is configured to set a minimum safety distance for the subject vehicle to an obstacle in order for the subject vehicle to avoid closely approaching the obstacle; an emergency control unit that is configured to: determine whether the subject vehicle is traveling with the safety distance; and execute emergency control for the subject vehicle that is different from normal control according to one of the driving plans when a distance between the subject vehicle and the obstacle is less than the safety distance; a caution zone setting unit that is configured to, when a moving obstacle is located ahead of the subject vehicle, set a caution zone for the subject vehicle that is located away from the subject vehicle over the safety distance and is between the moving obstacle and the subject vehicle; and a path selection unit that is configured to select, from among the generated driving plans, a driving plan along which the subject vehicle will travel such that the moving obstacle does not come in the caution zone for the subject vehicle.

### BRIEF DESCRIPTION OF DRAWINGS

FIG. 1 is a block diagram depicting a vehicle system according to a first embodiment.

FIG. 2 is a block diagram showing a path checking unit.

FIG. 3 is a diagram for explaining a caution distance from a preceding vehicle.

FIG. 4 is a diagram showing an RSS model with a formula.

FIG. 5 is a diagram for explaining derivation of the formula shown in FIG. 4.

FIG. 6 is a diagram for explaining a caution distance to a vehicle traveling on a right (left) side.

FIG. 7 is a diagram for explaining a subject-vehicle caution zone and a moving-obstacle caution zone.

FIG. 8 is a diagram for explaining a parking-lot caution zone.

FIG. 9 is a flowchart showing a process of setting a caution zone mode.

FIG. 10 is a flowchart showing a process of setting a caution zone.

FIG. 11 is a diagram for explaining the caution zone.

FIG. 12 is a flowchart showing a process of setting a parking-lot caution zone.

FIG. 13 is a flowchart showing a process of setting a parking-lot caution zone for a surrounding vehicle.

FIG. 14 is a diagram for explaining the parking-lot caution zone.

FIG. 15 is a diagram showing processing executed when the caution zone mode is set according to a second embodiment.

FIG. 16 is a diagram showing processing executed when the caution zone mode is set according to a third embodiment.

FIG. 17 is a diagram illustrating a safety area.

### DESCRIPTION OF EMBODIMENTS

To begin with, a relevant technology will be described only for understanding the following embodiments. In a typical navigation system, to secure safety for the subject vehicle, an emergency stop mode is implemented in which the subject vehicle makes an emergency stop when another vehicle invades the safety distance of the subject vehicle during automated-driving of the subject vehicle. Since the safety distance is calculated using the speed of the subject vehicle, the safety distance decreases when the subject vehicle is traveling at low speed in a parking lot or the like. If the safety distance is small, the actual vehicle-to-vehicle distance is also reduced. If the vehicle-to-vehicle distance is small, the subject vehicle may encounter a risk of “deadlock” where the subject vehicle cannot move forward and backward when the subject vehicle needs to go backward due to the safety distance set for the following vehicle.

One of objectives of the present disclosure is therefore to provide a path checking device and a path checking method that are designed to reduce occurrence of the deadlock.

A first aspect of the present disclosure is a path checking device for a subject vehicle including a path generation unit that generates a plurality of driving plans for the subject vehicle to travel by automated-driving and a travel control unit that controls traveling of the subject vehicle according to one of the driving plans. The path checking device includes: a safety distance setting unit that is configured to set a minimum safety distance for the subject vehicle to an obstacle in order for the subject vehicle to avoid closely approaching the obstacle; an emergency control unit that is configured to: determine whether the subject vehicle is traveling with the safety distance; and execute emergency control for the subject vehicle that is different from normal control according to one of the driving plans when a distance between the subject vehicle and the obstacle is less than the safety distance; a caution zone setting unit that is configured to, when a moving obstacle is located ahead of the subject vehicle, set a caution zone for the subject vehicle that is located away from the subject vehicle over the safety distance and is between the moving obstacle and the subject vehicle; and a path selection unit that is configured to select, from among the generated driving plans, a driving plan along which the subject vehicle will travel such that the moving obstacle does not come in the caution zone for the subject vehicle.

According to the first aspect, when a moving obstacle is located ahead of the subject vehicle, the caution zone setting unit sets the caution zone that is located away from the subject vehicle over the safety distance and is between the moving obstacle and the subject vehicle. Then, the path selection unit selects, from among the generated driving plans, a driving plan along which the subject vehicle will travel such that the moving obstacle does not come in the set caution zone. By setting the caution zone, it is possible to prevent the subject vehicle from approaching the moving obstacle within the safety distance, thereby suppressing occurrence of the deadlock.

A second aspect of the present disclosure is a path checking device for a subject vehicle including a path generation unit that generates a plurality of driving plans for the subject vehicle to travel by automated-driving and a travel control unit that controls traveling of the subject vehicle according to one of the driving plans. The path checking device includes: a safety distance setting unit that is configured to set a minimum safety distance for the subject vehicle to an obstacle in order for the subject vehicle to avoid closely approaching the obstacle; an emergency control unit that is configured to: determine whether the subject vehicle is traveling with the safety distance; and execute emergency control for the subject vehicle that is different from normal control according to one of the driving plans when a distance between the subject vehicle and the obstacle is less than the safety distance; a caution zone setting unit that is configured to: set a parking-lot caution zone for the subject vehicle that includes a travel path from a current position of the subject vehicle to a parking area when the subject vehicle is traveling to park in the parking area; and set a moving-obstacle caution zone for a moving obstacle around the moving obstacle when the moving obstacle is located ahead of the subject vehicle; and a path selection unit that is configured to select a driving plan along which the subject vehicle will travel to park in the parking area when the parking-lot caution zone for the subject vehicle and the moving-obstacle caution zone for the moving obstacle do not overlap with each other.

According to the second aspect, it is possible to select a more appropriate driving plan for the subject vehicle to park in the parking area while avoiding occurrence of the deadlock.

A third aspect of the present disclosure is a path checking method executed by a processor used in a subject vehicle that travels according to one of a plurality of driving plans by automated-driving. The method includes: setting a minimum safety distance for the subject vehicle to an obstacle in order for the subject vehicle to avoid closely approaching the obstacle; determining whether the subject vehicle is traveling with the safety distance; executing emergency control for the subject vehicle that is different from normal control according to one of the driving plans when a distance from the subject vehicle to the obstacle is less than the safety distance; when a moving obstacle is located ahead of the subject vehicle, setting a caution zone for the subject vehicle that is located away from the subject vehicle over the safety distance and is between the moving obstacle and the subject vehicle; and selecting, from among the generated driving plans, a driving plan along which the subject vehicle will travel such that the moving obstacle does not come in the caution zone for the subject vehicle.

A fourth aspect of the present disclosure is a path checking method executed by a processor used in a subject vehicle that travels according to a driving plan by automated-driving. The method includes: setting a minimum safety distance for the subject vehicle to an obstacle in order for the subject vehicle to avoid closely approaching the obstacle; determining whether the subject vehicle is traveling with the safety distance; executing emergency control for the subject vehicle that is different from normal control according to the driving plan when a distance from the subject vehicle to the obstacle is less than the safety distance; setting a parking-lot caution zone for the subject vehicle that includes a travel path from a current position of the subject vehicle to a parking area when the subject vehicle is traveling to park in the parking area; setting a moving-obstacle caution zone for a moving obstacle around the moving obstacle when the moving obstacle is located ahead of the subject vehicle; and selecting a driving plan along which the subject vehicle will travel to park in the parking area when the parking-lot caution zone for the subject vehicle and the moving-obstacle caution zone for the moving obstacle do not overlap with each other.

According to the third and fourth aspects, occurrence of the deadlock can be avoided.

Hereinafter, multiple embodiments for implementing the present disclosure will be described with reference to the drawings. In each embodiment, a part corresponding to the part described in the preceding embodiment may be denoted by the same reference numeral or a reference numeral with one character added to a preceding reference numeral; thereby, redundant explanation may be omitted. In each embodiment, when only part of the configuration is described, the other part of the configuration can be the same as that in a preceding embodiment. The present disclosure is not limited to combinations of embodiments which combine parts that are explicitly described as being combinable. As long as no problems are present, the various embodiments may be partially combined with each other even if not explicitly described.

### First Embodiment

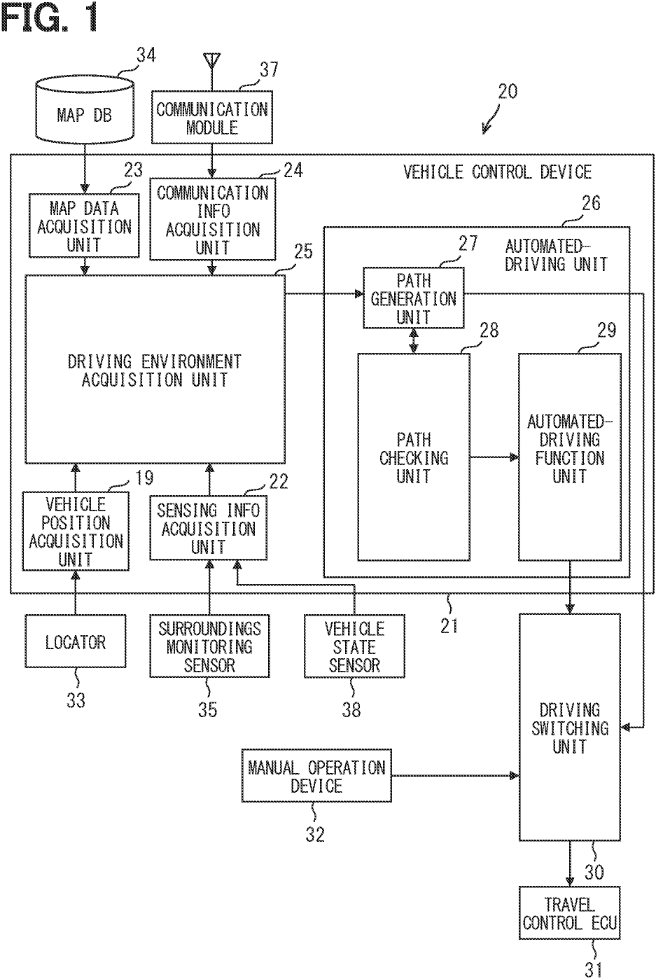

Hereinafter, a first embodiment of the present disclosure will be described with reference to FIGS. 1 to 14. A vehicle system 20 shown in FIG. 1 is used for a vehicle configured to perform an automated-driving (hereinafter referred to as an automated-driving vehicle). As depicted in FIG. 1, the vehicle system 20 includes a vehicle control device 21, a travel control electronic control unit (Electronic Control Unit: abbreviated to ECU) 31, a locator 33, a map database 34, a surroundings monitoring sensor 35, a communication module 37, a vehicle state sensor 38, a manual operation device 32, and a driving switching unit 30. Although the vehicle using the vehicle system 20 is not necessarily limited to an automobile, hereinafter, an example using the automobile will be described.

First, the automated-driving vehicle will be described. The automated-driving vehicle may be a vehicle capable of performing automated-driving as described above. The degree of the automated-driving (hereinafter, referred to as an automation level) includes multiple levels as defined by SAE, for example. According to the SAE definition, for example, the automation levels are categorized into the following levels.

Level 0 is a level where the driver performs all driving tasks without any intervention of the system. The driving tasks include, for example, a steering control, an acceleration, and a deceleration. The level 0 corresponds to so-called manual driving using a manual operation device 32. Level 1 is a level where the system assists the steering control or the acceleration and deceleration. Level 2 is a level where the system assists the steering control, the acceleration and deceleration. Each of the levels 1 and 2 corresponds to so-called driving assistance.

The level 3 is a level where the system performs all driving tasks in a certain location, such as a highway, and the driver performs driving in an emergency. In the level 3, the driver must be able to respond quickly when the system requests for a driver change. The level 3 corresponds to so-called conditional automated-driving. Level 4 is a level where the system is capable of performing all driving tasks, except under a specific circumstance, such as an unsupported road, an extreme environment, and the like. The level 4 corresponds to so-called highly automated driving. Level 5 is a level where the system is capable of performing all driving tasks in any situation. The level 5 corresponds to so-called fully automated-driving. The levels 3-5 correspond to so-called automated-driving. The driving task here may be a dynamic driving task (DDT).

The automated-driving vehicle of the present embodiment may be, for example, an automated-driving vehicle with an automation level of level 3, or an automated-driving vehicle with an automation level of level 4 or higher. The automation level may be switchable. In this embodiment, it is possible to switch between automated-driving at automation level 3 or higher and manual driving at level 0. Switching from automation level 3 to automation level 2 and switching from automation level 3 to automation level 1 may also be allowed. If automation levels 2, 1 are possible, it may be possible to switch between automation levels 2, 1, 0.

Next, the configuration of each element will be described. The locator 33 includes a GNSS (Global Navigation Satellite System) receiver and an inertial sensor. The GNSS receiver is configured to receive positioning signals from multiple positioning satellites. The inertial sensor includes a gyro sensor and an acceleration sensor, for example. The locator 33 sequentially measures a vehicle position of the subject vehicle by combining the positioning signals received by the GNSS receiver and the measurement results of the inertial sensor. The vehicle position may be represented by, for example, coordinates of latitude and longitude. The vehicle position may be measured using a travel distance obtained from signals sequentially output from a vehicle speed sensor mounted in the vehicle.

The map database 34 is a nonvolatile memory and stores map data such as link data, node data, road shapes, buildings and the like. The link data includes various data such as a link ID that identifies the link, a link length that indicates the length of the link, a link direction, a link travel time, a link shape, node coordinates between the start and end of the link, and road attributes. As one example, the link shape may include a coordinate sequence representing coordinate positions of shape interpolation points representing a shape formed of both ends of the link and a position between the both ends. The road attributes include a road name, a road type, a road width, lane number information indicating the number of lanes, a speed regulation value, and the like. The node data includes a various pieces of data such as a node ID in which a unique number is assigned to each node on a map, node coordinates, a node name, a node type, a connection link ID in which a link ID of a link connected to the node is described, and the like. The link data may be subdivided by lane, that is, by road line, in addition to by road section.

From the lane number information and/or the road type, it is possible to determine whether a road section, i.e., a link, corresponds to a road with multiple lanes, a single lane, or a two-way road with no center line. The two-way roads without a central line do not include one-way roads. Note that the center line can also be called a central line. The two-way road without a center line here refers to a two-way road without a center line among general roads other than highways and motorways.

The map data may include a three-dimensional map including feature points of road shapes and buildings. When the three-dimensional map including the feature points of the road shapes and buildings is used as the map data, the locator 33 may be configured to identify the subject vehicle position using the detection results of a LIDAR (Light Detection and Ranging/Laser Imaging Detection and Ranging) configured to detect the feature points of the road shapes and the buildings or the surroundings monitoring sensor 5 such as a surroundings monitoring camera. The three-dimensional map may be generated by REM (Road Experience Management) based on captured images.

The surroundings monitoring sensor 35 is an autonomous sensor that monitors a surroundings environment of the subject vehicle. As one example, the surroundings monitoring sensor 35 recognizes moving objects such as pedestrians, animals other than human, and moving bodies such as vehicles other than the subject vehicle, and static objects such as guardrails, curbs, trees, and fallen objects on the road. The surroundings monitoring sensor 35 further detects a road surface marking such as a traffic lane marking around the subject vehicle. For example, the surroundings monitoring sensor 35 may be a surroundings monitoring camera that captures an image of predetermined range around the subject vehicle. The surroundings monitoring sensor 35 may be a distance measuring sensor that emits a scanning wave toward a predetermined range around the subject vehicle. For example, the distance measuring sensor may be a millimeter wave radar, a sonar, or a lidar.

The vehicle state sensor 38 is a sensor group for detecting various states of the vehicle. The vehicle state sensor 38 includes a vehicle speed sensor, a steering sensor, an acceleration sensor, a yaw rate sensor, and the like. The vehicle speed sensor detects a vehicle speed of the own vehicle. The steering sensor detects a steering angle of the subject vehicle. The acceleration sensor detects the acceleration in a front rear direction of the subject vehicle and the acceleration in a lateral direction of the subject vehicle. The acceleration sensor may also detect a deceleration of the subject vehicle, that is, a negative acceleration. The yaw rate sensor detects an angular velocity of the own vehicle.

The communication module 37 performs vehicle-to-vehicle communication, which is transmission and reception of information, via wireless communication with the communication modules 37 of the vehicle systems 20 mounted in vehicles surrounding the subject vehicle. The communication module 37 may transmit and receive information via wireless communications with roadside devices installed on roadsides. In this case, the communication module 37 may receive information of the surrounding vehicle transmitted from the communication module 37 of the vehicle system 20 mounted in the surrounding vehicle around the subject vehicle via the roadside device.

Further, the communication module 37 may perform wider-area communication by transmitting and receiving information to and from a center outside of the subject vehicle via wireless communications. When vehicles transmit and receive information to each other via a center by wide-area communication, by transmitting and receiving information including vehicle positions, the center may control the communication using the vehicle positions such that vehicles within a certain range can share the information with each other. In the following description, the communication module 37 receives information about vehicles around the subject vehicle by at least one of vehicle-to-vehicle communication, road-to-vehicle communication, and wide-area communication.

Alternatively, the communication module 37 may receive map data distributed from an external server that is configured to distribute map data, for example, through wide-area communication and may store the received map data in the map database 34 . In this case, the map database 34 may be a volatile memory, and the communication module 37 may sequentially acquire the map data of an area corresponding to the subject vehicle position.

The manual operation device 32 is a device manually operated by a driver to drive the vehicle, and includes a steering wheel, an accelerator pedal, and a brake pedal. The manual operation device 32 outputs an operation amount operated by the driver to the driving switching unit 30 . The operation amount includes an accelerator operation amount, a brake operation amount, and a steering operation amount. During the automated-driving mode, the vehicle control device 21 outputs an instruction value for executing automated-driving.

The driving switching unit 30 switches the operation mode between an automated-driving mode in which automated-driving is performed and a manual-driving mode in which manual-driving is performed. In other words, the driving switching unit 30 switches the authority to drive the subject vehicle between the vehicle control device 21 and the driver. When the vehicle control device 21 is given the authority to drive the subject vehicle, the driving switching unit 30 transmits an instruction value output from the vehicle control device 21 to the travel control ECU 31 . The driving switching unit 30 transmits the operation amount by the driver to the travel control ECU 31 when the driver is authorized to operate the subject vehicle.

The driving switching unit 30 switches the operation mode between the automated-driving mode and the manual-driving mode according to a mode switching request. There are two types of mode switching requests: a manual-driving mode switching request for changing the operation mode from the automated-driving mode to the manual-driving mode; and an automated-driving mode switching request for changing the operation mode from the manual-driving mode to the automated-driving mode. The driving switching request is generated, for example, by a driver’s switch operation and input to the driving switching unit 30 . Also, the mode switching request is generated, for example, by a judgment of the vehicle control unit 21 and is input to the driving switching unit 30. The driving switching unit 30 switches the operation mode according to the mode switching request.

The travel control ECU 31 is a travel control unit, and is an electronic control unit that controls travelling of the subject vehicle. The traveling control includes acceleration/deceleration control and/or steering control. The travel control ECU 31 includes a steering ECU that performs steering control, a power unit control ECU and a brake ECU that perform acceleration/deceleration control, and the like. The travel control ECU 31 is configured to perform the traveling control by outputting control signals to traveling control devices such as an electronic throttle, a brake actuator, and an EPS (Electric Power Steering) motor.

The vehicle control unit 21 includes, for example, a processor, a memory, an I/O, and a bus that connects those devices, and executes various processes related to the automated-driving by executing a control program stored on the memory. The memory referred to here is a non-transitory tangible storage medium for storing programs and data that can be read by a computer non-transitory way. The non-transitory tangible storage medium is embodied by a semiconductor memory or a magnetic disk.

Subsequently, the schematic configuration of the vehicle control unit 21 will be described with reference to FIG. 1. As shown in FIG. 1, the vehicle control unit 21 includes, as functional blocks, a vehicle position acquisition unit 19, a sensing information acquisition unit 22, a map data acquisition unit 23, a communication information acquisition unit 24, a driving environment acquisition unit 25, and an automated-driving unit 26. Some or all of the functions executed by the vehicle control unit 21 may be formed as hardware with one or more ICs or the like. A part or all of the functional blocks included in the vehicle control unit 21 may be realized by executing software by a processor and a combination of hardware members. This vehicle control unit 21 corresponds to an in-vehicle device.

The vehicle position acquisition unit 19 acquires a vehicle position of the subject vehicle that is sequentially positioned by the locator 33 . The sensing information acquisition unit 22 acquires sensing information, which is the result of detection performed by the surroundings monitoring sensor 35 . The sensing information acquisition unit 22 also acquires vehicle state information, which is the result of detection performed by the vehicle state sensor 38 .

The map data acquisition unit 23 acquires map data stored in the map database 34 . The map data acquisition unit 23 may acquire map data of surroundings of the subject vehicle according to the vehicle position of the subject vehicle acquired by the subject vehicle position acquisition unit 19 . The map data acquisition unit 23 preferably acquires map data in a range wider than the detection range of the surroundings monitoring sensor 35 .

The communication information acquisition unit 24 acquires information about surrounding vehicles around the subject vehicle using the communication module 37. The information about the surrounding vehicles includes, for example, identification information, speed information, acceleration information, yaw rate information, position information, etc. of the surrounding vehicles. Identification information is information for identifying each vehicle. The identification information may include, for example, classification information indicating a predetermined classification such as a vehicle type and a vehicle class to which the vehicle corresponds.

The driving environment acquisition unit 25 acquires a driving environment of the subject vehicle and generates a virtual space simulating the driving environment acquired by the automated-driving unit 26. Specifically, the driving environment acquisition unit 25 recognizes the driving environment of the subject vehicle based on a vehicle position of the subject vehicle acquired by the vehicle position acquisition unit 19, sensing information and vehicle state information acquired by the sensing information acquisition unit 22, map data acquired by the map data acquisition unit 23, the driving environment of the subject vehicle acquired by the communication information acquisition unit 24, and the like. As an example, the driving environment acquisition unit 25 uses such information to recognize the positions, shapes, travelling states, etc. of objects around the subject vehicle, and the positions of road markings around the subject vehicle, and then generates a virtual space where the actual driving environment is reproduced.

The driving environment acquisition unit 25 also recognizes, from the sensing information acquired by the sensing information acquisition unit 22, a distance between the subject vehicle and the surrounding object, the relative speed of the surrounding object with respect to the subject vehicle, the shape and size of the surrounding object, etc., as the driving environment. In addition, when the communication information acquisition unit 24 is able to acquire information on surrounding vehicles, the driving environment acquisition unit 25 may be configured to recognize the driving environment using the information on the surrounding vehicles. For example, the position, speed, acceleration, yaw rate, etc. of the surrounding vehicle may be recognized from information such as the position, speed, acceleration, yaw rate, etc. of the surrounding vehicle. Also, performance information such as a maximum deceleration and a maximum acceleration of the surrounding vehicle may be recognized from identification information of the surrounding vehicle. As one example, a correspondence relationship between the identification information and the performance information may be stored in advance in a non-volatile memory of the vehicle control device 21, and the performance information may be recognized from the identification information by referring to the stored relationship.. Note that the aforementioned classification information may be used as the identification information.

It is preferable that the driving environment acquisition unit 25 may distinguish whether the surrounding object detected by the surroundings monitoring sensor 35 is a moving object or a stationary object. Moreover, it is preferable that the driving environment recognizing unit distinguishes and recognizes the type of surrounding object. The type of surrounding object can be distinguished and recognized by, for example, performing pattern matching on an image captured by a surrounding monitoring camera. As for types, for example, a structure such as a guardrail, an object falling on the road, a pedestrian, a bicycle, a motorcycle, an automobile, or the like may be distinguished and recognized. If the surrounding object is an automobile, the type of the surrounding object may be a vehicle class, a vehicle type, or the like. Whether the surrounding object is a moving object or a stationary object can be recognized according to the type of the surrounding object. For example, when the type of the surrounding object is a structure or an object falling on the road, the surrounding object may be recognized as a stationary object. When the type of the surrounding object is a pedestrian, a bicycle, a motorcycle, or an automobile, the surrounding object may be recognized as a moving object. An object that is unlikely to move immediately, such as a parked vehicle, may be recognized as a stationary object. A parked vehicle may be recognized when the vehicle is stopped and its brake lamp is not on by image recognition.

The automated-driving unit 26 performs processing related to substitution of driving operation by the driver. As shown in FIG. 1, the automated-driving unit 26 includes a path generation unit 27, a path checking unit 28, and an automated-driving function unit 29 as sub-functional blocks. In order to improve the performance in automated-driving, the automated-driving unit 26 is designed considering avoidance of unreasonable risks and positive risk balance.

The path generation unit 27 uses the driving environment acquired by the driving environment acquisition unit 25 to generate a driving plan for driving the subject vehicle by automated-driving. The driving environment here may be a traffic scenario (hereinafter, simply referred to as a scenario) itself, or a scenario may be selected in the process of using the driving environment in generating a driving plan. For example, a route search process is performed to generate a recommended route, as a med-to-long term driving plan, from the current position of the subject vehicle to the destination. In addition, as a short-term driving plan for driving in accordance with the med-to-long-term driving plan, a driving plan for changing lanes, a driving plan for driving in the center of the lane, a driving plan for following the preceding vehicle, an obstacle avoidance driving plan, and the like are generated. These driving plans can be a plan for keeping the subject vehicle 40 travelling. A plan for extremely short-term travel to bring the subject vehicle 40 to an emergency stop may need not be included in the driving plan here. Generation of a driving plan here may correspond to at least one of route planning (or path planning), tactical behavior planning, and trajectory planning.

The path generation unit 27 may generate, as a driving plan, a route that is a certain distance from, or in the center of, the recognized lane line, or a route that follows the recognized behavior of the preceding vehicle or the travel trajectory of the preceding vehicle. Further, the path generation unit 27 may generate, as a driving plan, a route for changing lanes of the subject vehicle to a vacant area in an adjacent lane extending in the same traveling direction. The obstacles here may be other road users. The other road users may include other vulnerable road users (e.g., pedestrians), other non-vulnerable road users (e.g., surrounding vehicles). The obstacles may also be considered as safety-related objects. The path generation unit 27 may generate, as a driving plan, a route for avoiding obstacles and maintaining travel or a deceleration plan for stopping prior to an obstacle. The path generation unit 27 may generate a driving plan determined to be optimal by machine learning or the like. The path generation unit 27 calculates, for example, one or more routes as a short-term driving plan. For example, the path generation unit 27 may include, in the short-term driving plan, acceleration/deceleration information for speed adjustment on the calculated route.

As an example, when a front obstacle recognized by the driving environment acquisition unit 25 is a travel interfering obstacle that interferes with traveling of the subject vehicle, the path generation unit 27 may generate a driving plan according to the situation while evaluating the validity by the path checking unit 28 as described later. In the following, the description will be made with an example where the travel interfering obstacle is recognized and specified. Note that the travel interfering obstacle may be a fallen object on the road, a parked vehicle, or a preceding vehicle in the travel lane of the subject vehicle. A preceding vehicle corresponding to the travel interfering obstacle may be a preceding vehicle which is travelling with average vehicle speed significantly lower than the regulation speed of the traveling road, even though the road is not congested. It should be noted that since slow driving is often required in a narrow road, it is preferable not to recognize preceding vehicles as an travel interfering obstacle in such narrow roads. In the following, when the driving path of the subject vehicle corresponds to a two-way road without a center line, moving objects such as preceding vehicles are not identified as obstacles, but stationary objects such as parked vehicles are identified as obstacles.

For example, when the driving environment acquisition unit 25 recognizes and identifies a travel interfering obstacle, the path generation unit 27 performs processing according to the travel route of the subject vehicle. For example, when the traveling road of the subject vehicle is a two-way road without a center line, the path generation unit 27 determines whether the subject vehicle can travel within the travel lines while securing a lateral distance with a threshold value or more between the travel interfering obstacle and the subject vehicle The threshold value may be a lower limit value that is set as a safety distance 42, as will be described later. The lower limit value may be, for example, a value of the safety distance 42 that is set when the subject vehicle travels while keeping the vehicle speed as low as possible. In other words, the path generation unit 27 determines whether the subject vehicle can travel within the travel lane while securing the safety distance 42 in the lateral direction between the subject vehicle and the travel interfering obstacle. The threshold value may be a predetermined fixed value, or if the travel interfering obstacle is a moving object, the threshold value may be a value that changes according to the behavior of the moving object.

As an example, the path generation unit 27 determines that the subject vehicle can travel within the travel lane while securing the safety distance 42 in the lateral direction between the subject vehicle and the travel interfering obstacle when the width of the travel lane is partially blocked by the travel interfering obstacle and the non-blocked portion of the travel lane is greater than the sum of the vehicle width of the subject vehicle and the above-described threshold value. If the subject vehicle is determined to travel within the travel lane while securing the safety distance 42 between the subject vehicle and the travel interfering obstacle, the path generation unit 27 may generate a driving plan where the subject vehicle travels along the travel lane while passing through the side of the travel interfering obstacle and avoiding an oncoming vehicle.

On the contrary, the path generation unit 27 determines that the subject vehicle cannot travel within the travel lane while securing the safety distance 42 in the lateral direction between the subject vehicle and the travel interfering obstacle when the non-blocked portion of the travel lane is equal to or less than the sum of the vehicle width of the subject vehicle and the above-described threshold value. As for the value of the vehicle width of the subject vehicle, a value stored in advance in the non-volatile memory of the vehicle control device 21 may be used. The lane width of the travel lane may be specified from map data acquired by the map data acquisition unit 23 . If the subject vehicle is determined not to travel within the travel lane while securing the safety distance 42 between the subject vehicle and the travel interfering obstacle, the path generation unit 27 may generate a driving plan where the subject vehicle stops. This is because when the subject vehicle is traveling on a two-way road with no center line and when the subject vehicle is determined not to travel within the travel lane while securing the safety distance 42 in the lateral direction between the subject vehicle and the travel interfering obstacle, it is not possible for the subject vehicle to travel. In this case, for example, the vehicle control device 21 may switch from automated-driving to manual-driving. In addition, when switching from automated-driving to manual-driving, switching to manual-driving may be performed after an advance notification of requesting for switching of driving is sent.

When the traveling road of the subject vehicle is a road with a plurality of lanes each way, the path generation unit 27 may generate a driving plan where the subject vehicle will make lane change to an adjacent lane in the same direction as the current lane of the subject vehicle. When the traveling road of the subject vehicle is a road with one-lane each way, the path generation unit 27 determines whether the subject vehicle can travel within the travel lines while securing a lateral distance with a threshold value or more between the travel interfering obstacle and the subject vehicle, as described above. If the subject vehicle is determined to travel within the travel lane while securing the safety distance 42 between the subject vehicle and the travel interfering obstacle, the path generation unit 27 may generate a driving plan where the subject vehicle travels along the travel lane while passing through the side of the travel interfering obstacle. If the travelling road of the subject vehicle is a road with one-lane each way and the subject vehicle is determined not to travel within the travel lane while securing the safety distance 42 between the subject vehicle and the travel interfering obstacle, the path generation unit 27 may generate a driving plan where the subject vehicle crosses over the travel lane while passing through a side of the travel interfering obstacle and avoiding an oncoming vehicle.

The path checking unit 28 evaluates the driving plan generated by the path generation unit 27 . The driving plan can also be referred to as a travel route. Evaluating a driving plan means executing a route verification method for validating the travel route. In order to facilitate the evaluation of the driving plan, the path checking unit 28 may evaluate the driving plan using a mathematical formula model that formulates the concept of safety driving. The path checking unit 28 may evaluate the driving plan by judging whether an inter-object distance, which is an inter-object distance between the subject vehicle and a surrounding object, is equal to or greater than a safety distance 42 which is calculated by a predetermined mathematical formula model and which serves as a reference for evaluating the inter-object relationship. For example, the inter-object distance may be a distance in the longitudinal direction and the lateral direction of the subject vehicle.

The mathematical formula model does not assure that an accident will not occur at all but assures that when a vehicle distance falls below the safety distance 42, the subject vehicle will take an appropriate action for avoiding collision. The appropriate action may be a proper response. The proper response may be a set of corrective actions that the driving policy (DP) might require to maintain the SOTIF (safety of the intended functionality) The proper response may be an action that resolves a critical situation when another road user behaves according to a reasonably foreseeable assumption. As an example of the proper response, shifting to a minimum risk condition may be performed. An example of the appropriate action for collision avoidance as mentioned herein is braking with a reasonable force. Braking with a reasonable force includes, for example, braking at a maximum deceleration available for the subject vehicle. The safety distance 42 calculated by the mathematical formula model can be rephrased as a minimum distance that the subject vehicle should keep between the subject vehicle and an obstacle in order to avoid closely reaching the obstacle.

The automated-driving function unit 29 causes the driving control ECU 31 to automatically accelerate, decelerate, and/or steer the subject vehicle according to the driving plan output from the path checking unit 28. That is, the automated-driving function unit 29 causes the ECU 31 to drive the subject vehicle on behalf of the driver, in other words, perform automated-driving. The automated-driving function unit 29 performs automated-driving according to the driving plan evaluated by the path checking unit 28 as usable for automated-driving. If the driving plan is to travel along a route, automated-driving along this route may be performed. If the driving plan is to stop or decelerate, the subject vehicle is automatically stopped or decelerated. The automated-driving function unit 29 performs automated-driving according to the driving plan output from the path checking unit 28 so that the subject vehicle automatically travels while avoiding closely reaching a surrounding object.

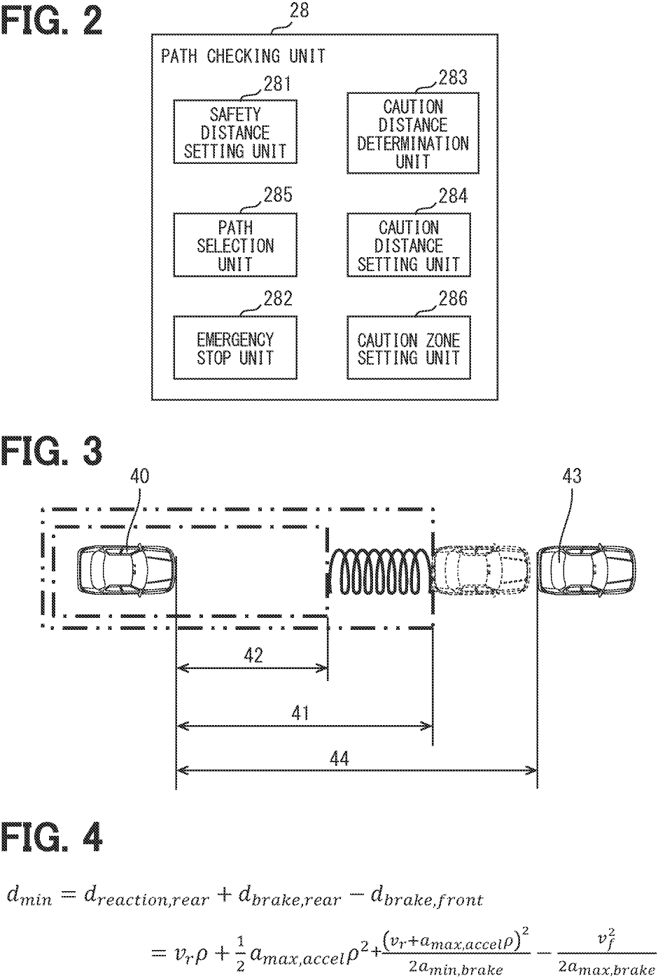

Next, the path checking unit 28 will be described in further detail. As shown in FIG. 2, the path checking unit 28 includes a safety distance setting unit 281, a caution distance setting unit 284, a caution distance determination unit 283, an emergency stop unit 282, a path selection unit 285, and a caution zone setting unit 286 as sub-functional blocks. The safety distance setting unit 281 calculates the safety distance 42 using the mathematical formula model described above and sets the calculated safety distance as the safety distance 42 . The safety distance setting unit 281 calculates and sets the safety distance 42 using at least information of behaviors of the vehicle. The safety distance setting unit 281 may use, for example, an RSS (Responsibility Sensitive Safety) model as a mathematical formula model. Here, the mathematical formula model may be a safety-related model itself, or may be a part of the safety-related model.

The safety distance setting unit 281 sets a minimum safety distance 42 that should be kept between the subject vehicle 40 and an obstacle in order to avoid closely approaching the obstacle. The safety distance setting unit 281 sets, for example, the safety distance 42 in a forward direction and left and right directions of the subject vehicle 40. For example, the safety distance setting unit 281 calculates, based on the information on the behaviors of the subject vehicle 40, a shortest distance in front of the subject vehicle 40 with which the subject vehicle 40 can stop as the safety distance 42, as shown in FIG. 3. As a specific example, the safety distance setting unit 281 may calculate, based on the speed, maximum acceleration, maximum deceleration, and response time of the subject vehicle 40, a distance, as the front safety distance 42, within which the subject vehicle can stop after the subject vehicle 40 traveled with the maximum acceleration from the current vehicle speed for the response time and then decelerated with the maximum deceleration. Here, the speed, maximum acceleration, and maximum deceleration of the subject vehicle 40 are those in the longitudinal direction of the subject vehicle 40. Also, the response time may be a time from an instruction for operating the braking device to the start of the operation when the subject vehicle 40 is stopped by automated-driving. As an example, the maximum acceleration, maximum deceleration, and response time of the subject vehicle 40 may be stored in advance in the non-volatile memory of the vehicle control device 21. Even when the safety distance setting unit 281 does not recognize a moving object but recognizes a stationary object in front of the subject vehicle, the safety distance setting unit 281 may set the front safety distance as a reference.

When the safety distance setting unit 281 recognizes a moving object in front of the subject vehicle, the safety distance setting unit 281 may calculate, based on the information on the behaviors of the subject vehicle 40 and the front moving object, a distance, within which the subject vehicle can stop without colliding with the moving object, as the front safety distance 42. In the following description, the moving object is assumed as an automobile vehicle. The moving object includes a preceding vehicle, an oncoming vehicle, and the like. As a specific example, when the moving directions of the subject vehicle 40 and the front moving object are opposite to each other, the safety distance setting unit 281 may calculate, based on the speeds, maximum accelerations, maximum decelerations, and response times of the subject vehicle 40 and the front moving object, a distance, as the front safety distance 42, within which the subject vehicle 40 and the front moving object can stop without colliding with each other after the subject vehicle 40 and the front moving object traveled with the maximum accelerations from the current speeds for the response times and then decelerated with the maximum decelerations. On the contrary, when the moving directions of the subject vehicle 40 and the front moving object are the same, the safety distance setting unit 281 may calculate a distance, as the front safety distance 42, within which the subject vehicle 40 and the front moving object can stop without colliding with each other after the front moving object decelerated with the maximum deceleration from the current speed and the subject vehicle 40 traveled with the maximum acceleration for the response time and then decelerated with the maximum deceleration.

If the speed, maximum acceleration, maximum deceleration, and response time of the moving object can be acquired by the communication information acquisition unit 24, the information acquired by the communication information acquisition unit 24 may be used by the safety distance setting unit 281.. As for the information that can be recognized by the driving environment acquisition unit 25, the information recognized by the driving environment acquisition unit 25 may be used. In addition, values of the maximum acceleration, maximum deceleration, and response time of a general, typical vehicle may be stored in advance on the non-volatile memory of the vehicle control unit 21, and the values of the general vehicle may be used, as the maximum acceleration, maximum deceleration, and response time of the moving object, by the safety distance setting unit 281. That is, a minimal set of reasonably foreseeable assumptions about behaviors of the moving object may be defined depending on a kinematic characteristics of the moving object and the scenario.

When the safety distance setting unit 281 recognizes a moving object behind the subject vehicle 40, the safety distance setting unit 281 may calculate, based on information on behaviors of the subject vehicle 40 and the rear moving object, a distance, within which the subject vehicle can stop without colliding with the rear moving object, as the backward safety distance 42. The rear moving object may include a following vehicle travelling in the same lane of the subject vehicle 40 and a following vehicle travelling in an adjacent lane of the subject vehicle 40 . The safety distance setting unit 281 may set the backward safety distance 42 for the subject vehicle 40 by estimating the safety distance 42 for the rear moving body in the same manner as calculating the front safety distance 42.

As shown in FIG. 6, the safety distance setting unit 281 sets, based on the behavior information of the subject vehicle 40, a distance in a lateral direction, as the safety distance 42, for which the subject vehicle 40 travels in the lateral direction until the speed of the subject vehicle 40 in the lateral direction decreases to zero for a shortest time. For example, the safety distance setting unit 281 may calculate, based on the speed, maximum acceleration, maximum deceleration, and response time of the subject vehicle 40 in the lateral direction, a distance for which the subject vehicle 40 would travel in the lateral direction during a time period after the subject vehicle 40 traveled with the maximum acceleration from the current speed in the lateral direction for the response time and then decelerated with the maximum deceleration until the speed of the subject vehicle in the lateral direction decreases to zero. Also, the response time may be a time from an instruction for operating the steering device to the start of the operation when the subject vehicle 40 is controlled by automated-driving. Even when the safety distance setting unit 281 does not recognize a moving object in the lateral direction but recognizes a stationary object on a side of the subject vehicle, the safety distance setting unit 281 may set the lateral safety distance 42 as a reference.

When the safety distance setting unit 281 recognizes a moving object in the lateral direction of the subject vehicle 40, the safety distance setting unit 281 may calculate, based on the information on behaviors of the subject vehicle 40 and the moving object, a distance in the lateral direction, for which the subject vehicle 40 and the moving object would travel in the lateral direction for a time period during which the speeds of the subject vehicle 40 and the moving object in the lateral direction decrease to zero without colliding with each other, as the lateral safety distance 42. As a specific example, the safety distance setting unit 281 may calculate, based on the speeds, maximum accelerations, maximum decelerations, and response times of the subject vehicle 40 and the moving object, a distance, as the lateral safety distance 42, within which the subject vehicle 40 and the moving object can stop without colliding with each other after the subject vehicle 40 and the moving object traveled in the lateral direction with the maximum accelerations from the current speeds for the response times and then decelerated with the maximum decelerations. Values of the maximum acceleration, maximum deceleration, and response time of an obstacle for calculating the safety distance 42 may be set according to an upper limit or a lower limit each of which is defined in a minimal set of assumptions that are reasonably foreseeable considered in a scenario.

The caution distance setting unit 284 sets a caution distance 41 that is greater than the safety distance 42 as a distance to be kept between the subject vehicle 40 and a surrounding vehicle 43 which is an obstacle traveling around the subject vehicle 40. The caution distance 41 includes the safety distance 42 therein and serves as a distance for preventing easily shifting to an emergency avoidance mode. The emergency avoidance mode is a control mode to perform a stop plan for suddenly decelerating and stopping the subject vehicle for safety. The surrounding vehicle 43 is another vehicle that travels around the subject vehicle 40. For example, a preceding vehicle travelling in front of the subject vehicle 40, a following vehicle travelling behind the subject vehicle 40, and a vehicle traveling an adjacent lane of the subject vehicle 40 may be included.

The safety distance 42 is calculated using the speed and acceleration of a preceding vehicle as described above, but if the acceleration/deceleration of the preceding vehicle is irregularly performed, the calculated results of the safety distance 42 may be unstable. In view of this, the caution distance 41 is introduced, and a driving plan where the vehicle-to-vehicle distance 44 is equal to or greater than the caution distance 41 is used as much as possible. If the vehicle-to-vehicle distance decreases to be smaller than the caution distance 41 due to sudden deceleration of the preceding vehicle, a driving plan is selected to expand the vehicle-to-vehicle distance 44 to be equal to or greater than the caution distance 41. Therefore, the caution distance 41 has a cushioning function as a virtual coil spring illustrated in in FIG. 3.

The caution distance setting unit 284 sets, for example, the caution distance 41 in a front direction and left and right directions of the subject vehicle 40. As shown in FIG. 3, when the surrounding vehicle 43 is a preceding vehicle, the caution distance setting unit 284 calculates, from the information on the behavior of the preceding vehicle, a distance, as the caution distance 41, within which the vehicle-to-vehicle distance 44 can be secured by performing slow deceleration. The slow deceleration is a deceleration that does not make the passenger feel uncomfortable, and this deceleration has been determined in advance through experiments or the like. The slow deceleration can also be a deceleration that does not cause the seat belt to be rocked. The distance within which the vehicle-to-vehicle distance 44 can be secured means that the vehicle-to-vehicle distance 44 with which an emergency stop mode would not be executed due to a predicted decrease in the safety distance 42 by this slow deceleration.

As a specific example, when the speed of a preceding vehicle is unstable and there is an unnatural speed difference Δv, a variation distance due to the speed difference Δv is calculated as an offset distance Δd, and the caution distance 42 is calculated by adding the offset distance Δd to the safety distance 42. The speed difference Δv is a difference between the maximum speed and the minimum speed of the preceding vehicle during a predetermined unit observation time. The unit observation time is a time for determining that the speed of the preceding vehicle is unstable, in other words, that the preceding vehicle travels in an erratic manner. Therefore, it is preferably that the unit observation time is less than 1 minute at the longest, and may be 10 seconds or less. The distance obtained by multiplying the speed difference Δv by the offset time is the offset distance Δd. The caution distance 41 is, as described above, a distance that serves as a buffer for the safety distance 42 . The offset distance Δd to be added to the safety distance 42 is preferably shorter than the safety distance 42 itself because the caution distance 41 acts like a buffer. The offset time is set so that the offset distance Δd is shorter than the safety distance 42.

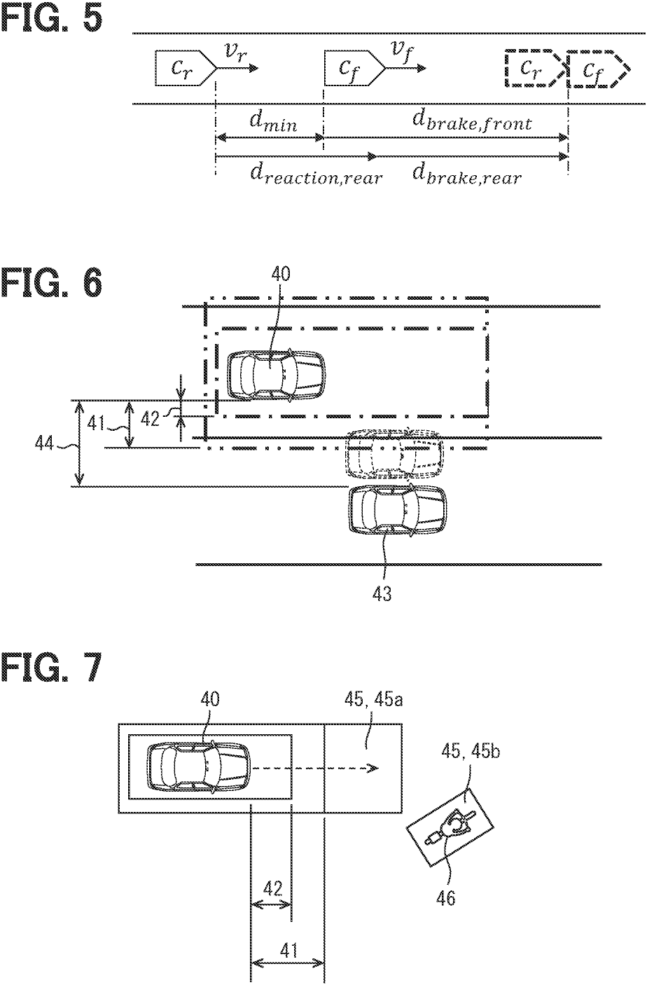

Furthermore, the distance can be calculated as the caution distance 41 by deleting the term relating to the braking distance of the preceding vehicle from the RSS model for calculating the safety distance 42. FIG. 4 shows an RSS model in which the distance of the preceding vehicle is not deleted. FIG. 4 shows a formula for calculating the safety distance 42 when a rear-end collision is determined. In FIG. 4, the safety distance 42 is indicated as dₘᵢₙ. The meaning of the middle side in FIG. 4 will be explained with reference to FIG. 5. FIG. 5 shows a relationship between the safety distance dₘᵢₙ in a situation where a rear-end collision is determined, a stopping distance d_{brake,front} of the vehicle c_{f} as a preceding vehicle, an idle running distance d_{reaction,rear} of the vehicle cᵣ as a following vehicle, and a braking distance d_{brake,rear} of the vehicle cr. This is expressed by an equation as shown in the relationship of FIG. 4 between the left side and the middle side.

Assuming that the vehicle c_{f} has a speed v_{f} at the start timing of deceleration and constant deceleration a_{max,} _{break} until the vehicle cf stops, the third term on the middle side can be converted to the fourth term on the right side. Assuming that the vehicle cᵣ is traveling at the speed vᵣ and then is accelerated at the maximum acceleration a_{max,accel} during the reaction time ρ, the first term on the middle side can be converted to the first and second terms on the right side. When the vehicle cᵣ decelerates at a constant deceleration aₘᵢₙ, break until the vehicle cᵣ stops after it starts decelerating, the second term on the middle side can be converted to the third term on the right side. From the above, the right side is obtained. The term relating to the braking distance of the preceding vehicle is the fourth term on the right side.

As shown in FIG. 6, when the surrounding vehicle 43 is a vehicle on the left or right side of the subject vehicle 40, the caution distance setting unit 284 calculates, based on the information on behaviors of the surrounding vehicle 43, a distance, as the caution distance 41, within which the subject vehicle 40 can secure the vehicle-to-vehicle distance 44 with soft steering. The soft steering is steering which generates the approximately same lateral acceleration as the lateral acceleration that is generated when a passenger normally operates the steering wheel. This lateral deceleration has been set in advance through experiment or the like. Furthermore, soft steering can be steering in which the seat belt is not locked. The distance within which the vehicle-to-vehicle distance 44 can be secured means that the vehicle-to-vehicle distance 44 with which an emergency stop mode would not be executed due to a predicted decrease in the safety distance 42 by this soft steering.

Further, the caution distance setting unit 284 sets the caution distance 41 when the subject vehicle 40 travels in a non-normal traveling place such as a parking lot. Each vehicle running in a parking lot travels with the caution distance 41 set for the vehicle . Then, each vehicle selects a driving plan so that the caution distances 41 do not overlap with each other. When traveling in a parking lot, the caution distance 41 is set according to a vehicle class rather than a vehicle speed. If the caution distances 41 overlap with each other, a driving plan to eliminate the overlap of the caution distances 41 by setting the vehicle-to-vehicle distance 44 greater than or equal to the caution distance 41. In a parking lot, for example, when the caution distance 41 for a surrounding vehicle 43 traveling in an opposite direction and the caution distance 41 for the subject vehicle 40 overlap with each other, if the overlap can be eliminated by moving the subject vehicle forward, the overlap is eliminated by prioritizing moving forward over moving backward.

The caution distance setting unit 284 sets the caution distance 41 based on a vehicle class of the subject vehicle 40 when traveling in a parking lot. The caution distance 41 for the surrounding vehicle 43 may be calculated by the subject vehicle 40 from the vehicle class of the surrounding vehicle 43, or may be acquired via inter-vehicle communication.

Whether to set such a caution distance 41 is determined by the caution distance determination unit 283 . Therefore, the caution distance 41 is always calculated by the caution distance setting unit 284 regardless of whether it is actually set. The caution distance determination unit 283 determines whether to set the caution distance 41 for the surrounding vehicle 43 . The caution distance determination unit 283 determines whether to set the caution distance 41 for the surrounding vehicle 43 when the safety distance 42 temporarily increases or when the safety distance 42 will increase in future. The caution distance 41 may always be set for the surrounding vehicle 43, but in this embodiment, the caution distance 41 is set only when a predetermined setting condition is satisfied. For example, when the safety distance 42 for the surrounding vehicle 43 temporarily increases, specifically when the traveling state of the surrounding vehicle 43 is not stable, or when there is a large curve ahead, the caution distance determination unit 283 determines to set the caution distance 41. Further, for example, when the safety distance 42 for the surrounding vehicle 43 will increase in future, specifically, when the road surface condition ahead badly changes, the caution distance determination unit 283 determines to set the caution distance 41. Therefore, when conditions are met where there is a high possibility that time variation of the calculated safety distance 42 will increase, and when there is a possibility that the safety distance 42 has a maximum value that is greater than the average value of the safety distance 42 for a predetermined elapsed time by a constant value or that increases at a constant ratio from the average value, the caution distance determination unit 283 determines to set the caution distance 41 .

When the caution distance 41 is set for the surrounding vehicle 43, the setting may be repeatedly, continuously performed as long as the surrounding vehicle 43 exists in the surroundings, but if a predetermined termination condition is met, the setting of the caution distance 41 may be terminated. In the present embodiment, when the caution distance determination unit 283 determines that a driving validity of the subject vehicle 40 is ensured after the caution distance 41 was already set for the surrounding vehicle 43, the caution distance determination unit 283 determines to terminate setting the caution distance 41 for the surrounding vehicle 41.

If a moving obstacle 46 traveling around the subject vehicle 40 exists, the caution zone setting unit 286 sets a caution zone 45 at a position that is outside of the safety distance 42 and is between the moving obstacle 46 and the vehicle 40. The caution zone 45 is an area located farther away from the subject vehicle 40 beyond the safety distance 42 of the subject vehicle 40 and is located between the moving obstacle 46 and the subject vehicle 40. The moving obstacle 46 may be a pedestrian, bicycle, vehicle, and the like that moves around the subject vehicle 40. The caution zone 45 is an area that extends two-dimensionally parallel to the road surface and is not a distance. As shown in FIG. 7 , for example, if a bicycle exists as a moving obstacle 46 in front of the subject vehicle 40, the caution zone 45 is virtually formed in front of the subject vehicle 40 as an area continuously expanding from the caution distance 41. Therefore, if a moving obstacle 46 exists, the caution zone setting unit 286 sets the caution zone 45 at a position that is outside of the caution distance 41 and is between the moving obstacle 46 and the vehicle 40 in a traveling direction.

The caution zone setting unit 286 uses information such as the speed of the subject vehicle 40 and the speed and traveling direction of the moving obstacle 46 to determine a distance of the caution zone 45 by adopting the distance within which the subject vehicle 40 can secure the vehicle-to-vehicle distance 44 to the moving obstacle 46 by soft deceleration. Therefore, for example, the width of the caution zone 45 is set to be equal to or greater than the caution distance 41. The length of the caution zone 45 along the traveling direction (the left-right direction in FIG. 7) is set, for example, to be equal to or greater than the caution distance 41.

The caution zone setting unit 286 sets the caution zone 45 for the moving obstacle around the moving obstacle 46. The caution zone 45 for the moving obstacle 46 is separately set from the caution zone 45 for the subject vehicle. The caution zone 45 for the subject vehicle may hereinafter be referred to as “subject-vehicle caution zone 45a”. Similarly, the caution zone 45 for the moving obstacle may hereinafter be referred to as “moving-obstacle caution zone 45b”. When the caution zone 45 is used as a generic term, a reference numeral “45” is attached. As shown in FIG. 7, for example, when a bicycle exists as the moving obstacle 46 in front of the subject vehicle 40, the moving-obstacle caution zone 45b is set, for example, to include he bicycle and spread with certain dimension. The moving-obstacle caution zone 45b extending a certain extent is adjusted according to the size of the moving obstacle 46. For example, if the moving obstacle 46 is a vehicle, the moving-obstacle caution zone 45b is set according to the vehicle class. The moving-obstacle caution zone 45b follows (or traces) the moving obstacle 46 when the moving obstacle 46 moves.

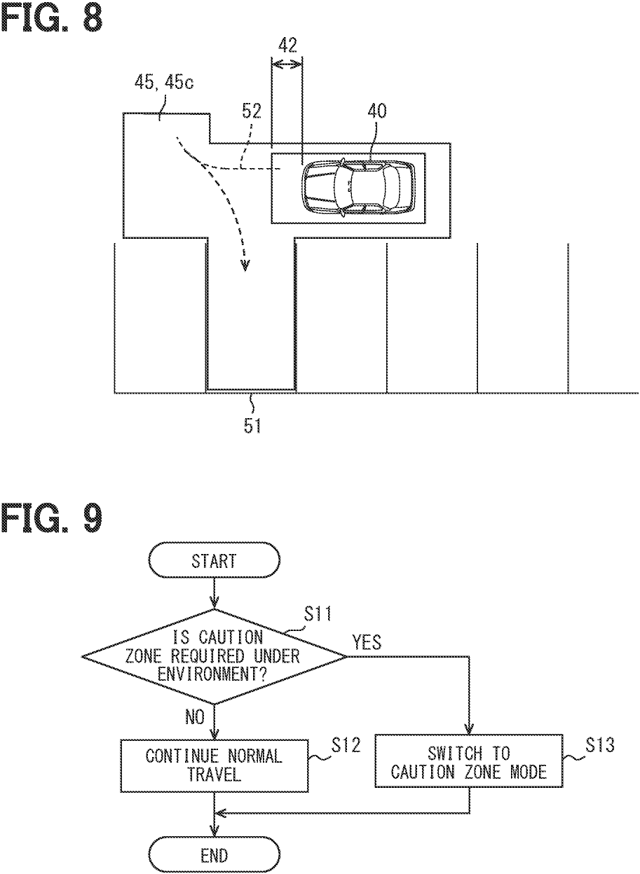

The caution zone setting unit 286 may adjust the size of the moving-obstacle caution zone 45b based on information such as the speed of the subject vehicle 40 and the speed and traveling direction of the moving obstacle 46. For example, the length of the moving-obstacle caution zone 45b may be calculated as a distance within which the subject vehicle 40 can secure the vehicle-to-vehicle distance 44 to the moving obstacle 46 by soft deceleration. Therefore, for example, the width of the moving-obstacle caution zone 45b is set to be equal to or greater than the caution distance 41. The length of the moving-obstacle caution zone 45b along the traveling direction is set, for example, to be equal to or greater than the caution distance 41. When the subject vehicle 40 is traveling to park in a parking space 51, the caution zone setting unit 286 sets the caution zone 45 for a parking lot that includes a travel path 52 from the current position of the subject vehicle 40 to the parking space 51 in addition to the subject-vehicle caution zone. 45a. Whether the subject vehicle 40 is traveling to park in the parking space 51 is determined from the parking destination set by user’s operation or the like. The travel path 52 during parking is an entire route including a path during reversing and turning for parking. The travel path 52 is set based on an ideal parking route from the current position of the subject vehicle 40 to the designated parking space 51. The caution zone 45 for a parking lot may hereinafter be referred to as a “parking-lot caution zone 45c”. The width of the parking-lot caution zone 45c is set according to the safety distance 42 and is set to be greater than the safety distance 42. As shown in FIG. 8, for example, when the subject vehicle 40 is traveling in a parking lot, a parking-lot caution zone 45c is set for the designated parking space 51. FIG. 8 is a simplified diagram. The parking-lot caution zone 45c is an area including the longitudinal and lateral safety distances 42 that change sequentially as the subject vehicle 40 travels along the travel path 52 Instead of using the safety distance 42 as described above, the parking-lot caution zone 45c may be an area including the longitudinal and lateral caution distances 41 that change sequentially as the subject vehicle 40 travels along the travel path 52

When the subject vehicle 40 is traveling in a parking lot and the moving obstacle 46 is a surrounding vehicle 43 traveling around the subject vehicle 40, the caution zone setting unit 286 predicts that the surrounding vehicle 43 will travel to park in a parking space 51. Then, the caution zone setting unit 286 sets the parking-lot caution zone 45c for the surrounding vehicle 43 that includes a travel path 52 from the current position of the surrounding vehicle 43 to the parking space 51 in addition to the subject-vehicle caution zone 45a. The parking space 51 expected to be parked by the surrounding vehicle 43 is a parking space around the surrounding vehicle 43, and it is preferable to consider not only the parking space 51 defined by white lines but also other available parking spaces. The parking space 51 expected to be parked by the surrounding vehicle 43 is set based on a parking space 51 existing within a predetermined range in front of the surrounding vehicle 43, and it is preferable not to include a parking space 51 that have been already passed by the surrounding vehicle 43. Therefore, if the vehicle shown in FIG. 8 is a surrounding vehicle 43, the subject vehicle 40 would set a caution zone 45c as illustrated in FIG. 8 as the parking-lot caution zone 45c for the surrounding vehicle 43.

The path selection unit 285 selects a driving plan for the automated-driving function unit 29 among from the driving plans generated by the path generation unit 27 . The path selection unit 285 verifies the validity of the driving plan generated by the path generation unit 27 using the safety distance 42 . Verification here may mean “judgment”. The driving plan selected by the path selection unit 285 must be a cautious plan or a semi-cautious plan. The cautious plan is a driving plan that secures the safety distance 42 with respect to target vehicle. The semi-cautious plan is a driving plan that secures the caution distance 41 with respect to the target vehicle. The semi-cautious plan is a driving plan in which the moving obstacle 46 does not enter the caution zone 45 when the caution zone 45 has been already set.

Further, the path selection unit 285 selects a parking plan from the driving plans generated by the path generation unit 27 when the subject vehicle is traveling in a non-normal travelling location such as a parking lot. The parking plan is a driving plan in which the caution zone 45 is set for each of the subject vehicle 40 and the surrounding vehicles 43. The parking plan is a driving plan such that the caution zones 45 of the subject vehicle 40 and the surrounding vehicle 43 do not overlap with each other, and is a driving plan that gradually eliminates the overlap even if they overlap with each other.

Therefore, when the caution zone 45 has been set, the path selection unit 285 selects a driving plan in consideration of the caution zone 45. Specifically, the path selection unit 285 selects a driving plan along which the subject vehicle travels such that the moving obstacle 46 does not come in the subject-vehicle caution zone 45a. Furthermore, the path selection unit 285 preferably selects a driving plan along which the subject vehicle travels such that the subject-vehicle caution zone 45a and the moving-obstacle caution zone 45b do not overlap with each other. Even if the caution zones 45 overlap with each other, the driving plan is designed to gently eliminate the overlap.

The emergency stop unit 282 is an example of an emergency control unit. The emergency stop unit 282 provides the automated-driving function unit 29 with a predetermined emergency stop plan. The emergency stop plan is a driving plan that should be selected in the absence of the cautious plan. The emergency stop plan provides, for example, a route for decelerating the subject vehicle 40 at the maximum deceleration until the subject vehicle 40 stops without changing the steering angle.

The emergency stop unit 282 determines repeatedly whether the subject vehicle is traveling while ensuring the safety distance 42 set by the safety distance setting unit 281 . Then, the emergency stop unit 282 controls the subject vehicle 40 to make an emergency stop when the safety distance 42 cannot be secured during traveling.

The emergency stop unit 282 provides the automated-driving function unit 29 with the predetermined emergency stop plan when the subject vehicle 40 needs to be stopped urgently. Thus, the emergency stop plan is a driving plan selected in the absence of the cautious plan. The emergency stop plan is, for example, a driving plan for decelerating the subject vehicle 40 with the maximum deceleration until the subject vehicle 40 stops without changing the steering angle.

When the subject vehicle 40 needs to be stopped urgently, the path generation unit 27 may generate a driving plan for stopping the subject vehicle 40 urgently while preferably avoiding sudden deceleration. An example of an emergency stop plan is a driving plan that slows the subject vehicle 40 by keeping applying the maximum possible deceleration until the subject vehicle 40 stops. However, for the emergency stop, the maximum possible deceleration need not necessarily be kept as long as deceleration is started immediately in order to stop the subject vehicle 40 .

Further, when the caution distance 41 is set, the emergency stop unit 282 repeatedly determines whether the subject vehicle is traveling while securing the caution distance 41. Then, the emergency stop unit 282 decelerates the subject vehicle when the vehicle-to-vehicle distance 44 decreases to be less than the caution distance 41, and controls the travel control ECU 31 so that the vehicle-to-vehicle distance 44 between the subject vehicle 40 and the surrounding vehicle 43 increases to be equal to or greater than the caution distance 41 (exceed the caution distance 41). Here, controlling the travel control unit may correspond to or include generating appropriate vehicle motion control requests.

Further, if the moving obstacle 46 enters the set caution zone 45, the emergency stop unit 282 controls the travel control ECU 31 to execute at least one of deceleration control and steering control so as to increase the distance to the moving obstacle 46. The deceleration control that is executed when the moving obstacle 46 enters the caution zone 45 is preferably slow deceleration that does not make the passenger feel uncomfortable, and this deceleration has been determined in advance through experiments or the like. The deceleration control that is executed when the moving obstacle 46 enters the caution zone 45 may be the same control as the above-described deceleration control of the caution distance 41. The steering control that is executed when the moving obstacle 46 enters the caution zone 45 is preferably gentle steering. For example, the steering is adjusted to generate a lateral acceleration similar to the lateral acceleration that is generated when an occupant normally operates the steering wheel. The lateral deceleration is set in advance thorough experiments or the like. The steering control that is executed when the moving obstacle 46 enters the caution zone 45 may be the same control as the above-described steering control of the caution distance 41.

Next, processing by the vehicle control device 21 will be described with reference to the flow charts of FIGS. 9, 10, 12 and 13. Each flowchart is a process that is repeatedly executed in a short time while the vehicle control device 21 is on. For example, these processes are repeatedly executed in the same or shorter time as the safety determination period of the path checking unit 28 .

First, the flowchart of FIG. 9 will be described. The flowchart shown in FIG. 9 is executed during normal traveling before the caution zone 45 is set. When the process shown in the flowchart of FIG. 9 starts, at step S11, the caution zone setting unit 286 determines whether the surrounding environment requires for setting of the caution zone 45. If the environment requires for setting of the caution zone 45, the process proceeds to step S13, while if the environment does not require, the process proceeds to step S12. Such an environment in which the caution zone 45 needs to be set is, for example, a situation where a moving obstacle 46 exists around the subject vehicle 40 or a situation where the subject vehicle 40 is traveling in a parking lot. At step S12, since the environment does not require for setting of the caution zone 45, the path selection unit 285 is controlled to select the cautious plan or the semi-cautious plan, and this process ends.

At step S13, since the environment requires for setting of the caution zone 45, the mode is switched to the caution zone mode, and the process ends. The caution zone mode is a mode in which the caution zone setting unit 286 sets the caution zone 45 and the path selection unit 285 evaluates the driving plan.

Next, the flowchart of FIG. 10 will be described. The flowchart shown in FIG. 10 is executed when the caution zone mode has been already set. When the process shown in the flowchart of FIG. 10 starts, at step S21, the subject-vehicle caution zone 45a is calculated, and the process proceeds to step S22. At step S22, the calculated subject-vehicle caution zone 45a is set, and the process proceeds to step S23. At step S23, the moving-obstacle caution zone 45b is calculated, and the process proceeds to step S24. At step S24, the calculated moving-obstacle caution zone 45b is set, and this flow ends.

By setting the caution zone 45, the path selection unit 285 selects, from among the driving plans generated by the path generation unit 27, a driving plan along which the subject vehicle will travel such that the moving obstacle 46 does not come in the subject-vehicle caution zone 45a. In this embodiment, since the caution zone 45 is also set for the moving obstacle 46, the path selection unit 285 selects, among from the generated driving plans, a driving plan such that the subject vehicle travels without overlapping between the set subject-vehicle caution zone 45a and the moving-obstacle caution zone 45b.

Furthermore, if the subject-vehicle caution zone 45a and the moving-obstacle caution zone 45b overlap with each other, the path selection unit 285 selects a driving plan where the distance between the subject vehicle and the moving obstacle 46 is maintained to be equal to or greater than the safety distance 42 and the overlap between the caution zones 45 is eliminated.

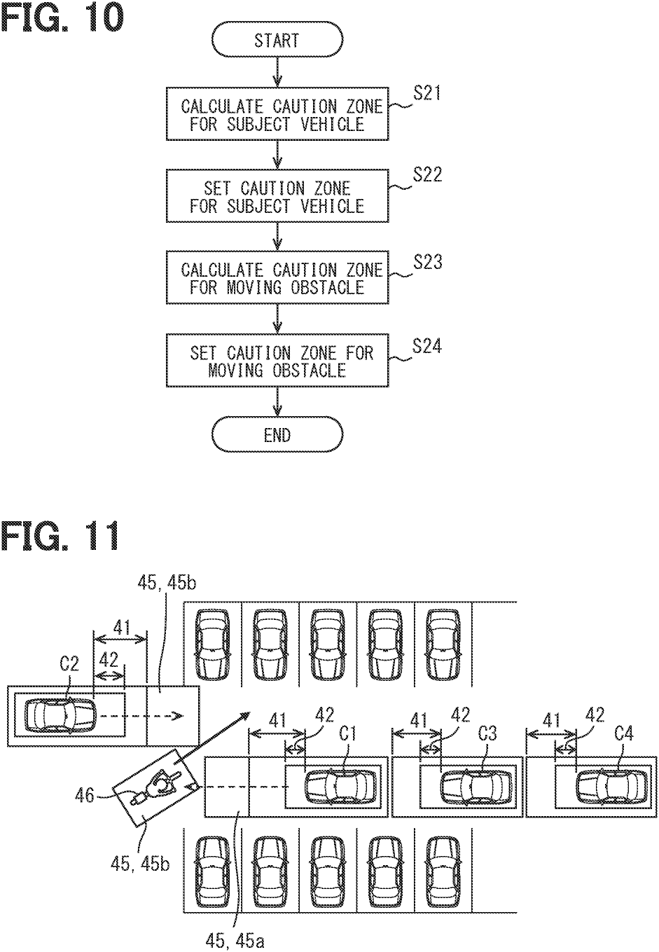

Next, an example of travel control during the caution zone mode will be described with reference to FIG. 11. In FIG. 11, for the sake of explanation, a traveling vehicle that is the subject vehicle 40 is denoted by reference numeral “C1”, a front vehicle ahead of the traveling vehicle C1 is denoted by reference numeral “C2”, and following vehicles of the traveling vehicle C1 are denoted by reference numerals “C3” and “C4”.

For example, as shown in FIG. 11, in a parking lot, the subject-vehicle caution zone 45a is set for the traveling vehicle C1, and the moving-obstacle caution zones 45b are set for the front vehicle C2 and a preceding bicycle. Then, when the bicycle tries to cross in front of the traveling vehicle C1, a driving plan is selected such that the moving-obstacle caution zone 45b for the bicycle and the subject-vehicle caution zone 45a do not overlap with each other. From the situation shown in FIG. 11, if the bicycle moves diagonally in the upper right direction indicated by the arrow in FIG. 11, the subject-vehicle caution zone 45a and the moving-obstacle caution zone 45b for the bicycle would overlap with each other. Thus, the traveling vehicle C1 stops to avoid the overlap. After the vehicle D1 stops, the subject-vehicle caution zone 45a and the moving-obstacle caution zone 45b for the bicycle are allowed to overlap with each other. Therefore, it is possible to secure a distance to the bicycle and prevent the subject vehicle D1 from interfering with traveling of the bicycle.

### Processing of Setting the Parking-Lot Caution Zone 45c for the Subject Vehicle 40

Next, the flowchart of FIG. 12 will be described. The flowchart shown in FIG. 12 is executed when the caution zone mode has been set. When the process shown in the flowchart of FIG. 12 starts, at step S31, it is determined whether the subject vehicle is in a parking mode where the subject vehicle identifies a parking space 51 in which the subject vehicle 40 is to be parked. If Yes, the process proceeds to step S32 and if not, the process ends. The parking space 51 may be set when the driver designates the parking space 51, or the caution zone setting unit 286 may select the parking space 51 upon receiving the driver’s instruction for parking. At step S32, since the mode is the parking mode, the subject-vehicle caution zone 45c is set, and this flow ends.

### Processing of Setting the Parking-Lot Caution Zone 45c for a Surrounding Vehicle 43

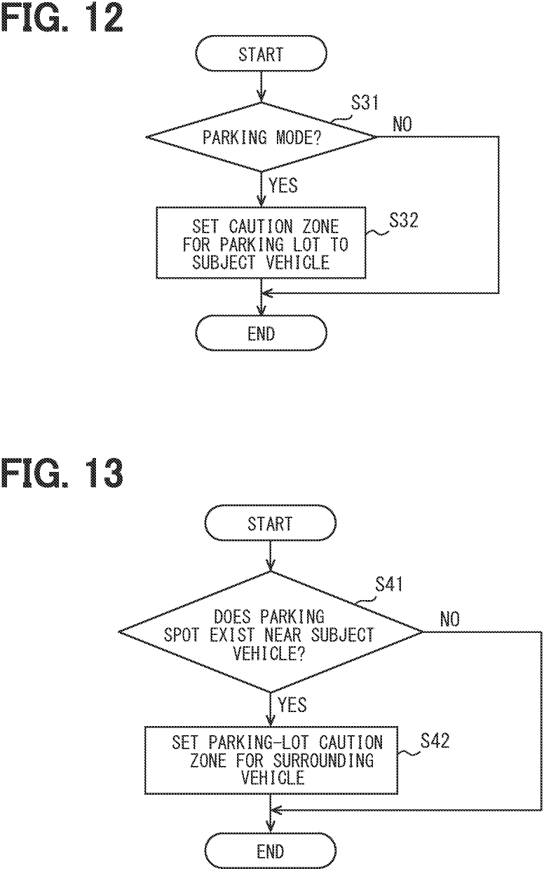

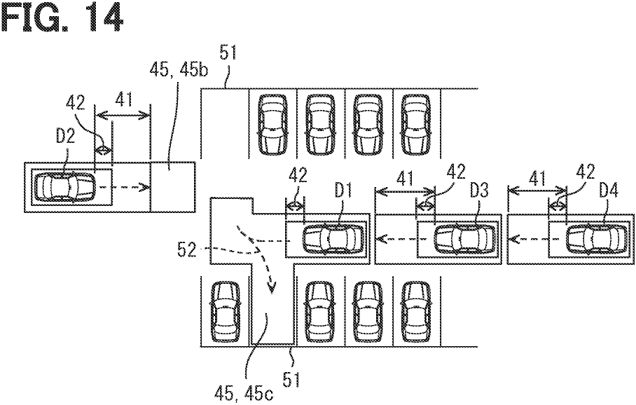

Next, the flowchart of FIG. 13 will be described. The flowchart shown in FIG. 13 is executed when the subject vehicle is traveling in a parking lot and the caution zone mode is set. When the process shown in the flowchart of FIG. 13 starts, at step S41, it is determined whether the parking spot around the surrounding vehicle 43 exists. If Yes, the process proceeds to step S42 and if not, the process ends. The parking spot is an area in which a vehicle can be parked or a parking area. The parking spot includes the parking space 51 that is not parked, or another space where parking is permitted. The surrounding vehicle 43 is a vehicle traveling in front of the subject vehicle 40 or a vehicle being temporarily stopped for parking. At step S42, if there is a surrounding vehicle 43, it may always be predicted, and it may be acquired by vehicle-to-vehicle communication that the surrounding vehicle 43 is in the parking mode. At step S42, since there is a parking spot near the surrounding vehicle 43, the parking-lot caution zone 45c is set for the surrounding vehicle 43, and this flow ends.

By setting the parking-lot caution zone 45c, the path selection unit 285 selects, among from the generated driving plans, a driving plan such that the subject vehicle travels without overlapping between the parking-lot caution zone 45c and the moving-obstacle caution zone 45b. Further, the path selection unit 285 selects, among from the generated driving plans, a driving plan such that the subject vehicle travels without overlapping between the subject-vehicle caution zone 45a and the parking-lot caution zone 45c for the surrounding vehicle 43. The path selection unit 285 controls the travel control ECU 31 to stop if there is no driving plan that avoids overlapping. That is, the path selection unit 285 selects a driving plan which gives a priority to the surrounding vehicle 43 for parking.

### Caution Area Mode in a Parking Lot

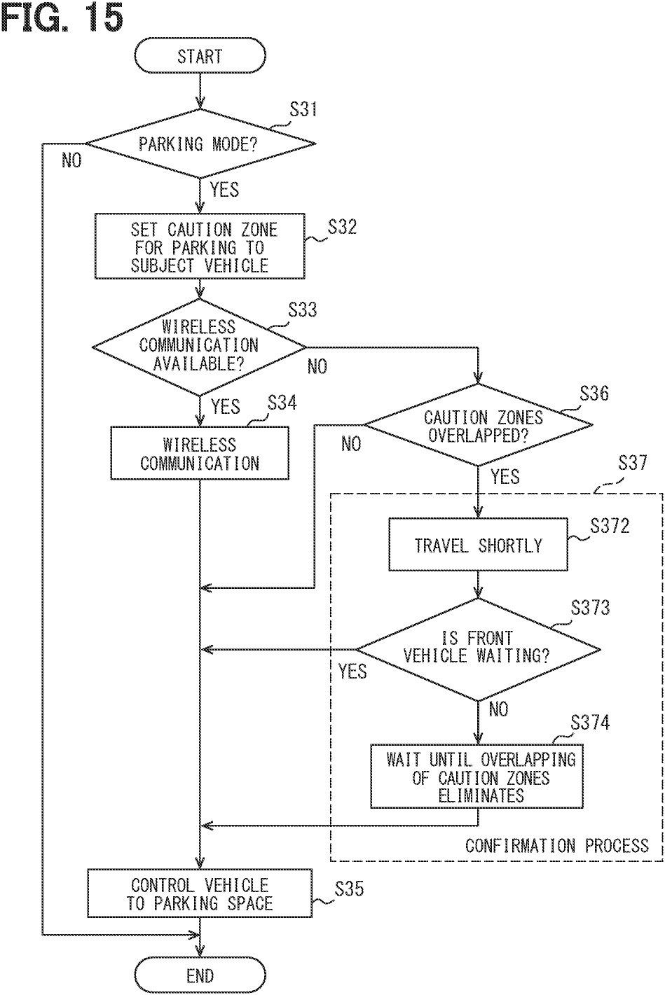

Next, an example of travel control during the caution zone mode in a parking lot will be described with reference to FIG. 14. In FIG. 14, for the sake of explanation, a parking vehicle traveling to be parked is denoted by reference numeral “D1”, a front vehicle ahead of the parking vehicle D1 is denoted by reference numeral “D2”, and following vehicles of the parking vehicle D1 are denoted by reference numerals “D3” and “D4”.

### When the Subject Vehicle 40 Is the Parking Vehicle D1

First, the case where the subject vehicle 40 is the parking vehicle D1 will be described. As described in the flow chart of FIG. 12, when the subject vehicle 40 is traveling in the parking lot and is the parking vehicle D1, the parking-lot caution zone 45c is set for the subject vehicle 40 as shown in FIG. 14. At this time, the parking-lot caution zone 45c may also be set by the front vehicle D2 for the same parking space 51. In this case, priority is given to the vehicle which set the area 45c first. Therefore, if the parking vehicle D1 sets the parking-lot caution zone 45c first, even if the parking-lot caution zone 45c is set for the same parking space 51 or a different parking space 51 facing the parking space 51 is set after the setting by the parking vehicle D1, priority is given to the parking vehicle D1. Therefore, the front vehicle D2 is waiting for its turn. At this time, the safety distance 42 of the front vehicle D2 is designed not to overlap with the parking-lot caution zone 45c of the parking vehicle D1.

If the prepared parking-lot caution zone 45c overlaps with the caution zone 45 for the surrounding vehicle 43, the parking vehicle D1 waits until the surrounding vehicle 43 moves and exits the parking-lot caution zone 45c. For example, if the front vehicle D2 moves forward a little more, that is, in a position moved to the right side in FIG. 14, the parking vehicle D1 waits until the front vehicle D2 passes away because the caution zone 45 for the front vehicle D2 and the parking-lot caution zone 45c for the parking vehicle D1 overlap with each other. As a result, the parking vehicle D1 can be prevented from closely approaching the surrounding vehicle 43 thanks to the parking-lot caution zone 45c even if the parking vehicle D1 makes turning.

### When the Subject Vehicle 40 Is the Front Vehicle D2 or the Following Vehicle D3

Next, a situation where the subject vehicle 40 is the front vehicle D2 or the following vehicle D3 will be described. When the front vehicle D2 or the following vehicle D3 finds a parking spot near a vehicle within the observation range, that is, a surrounding vehicle 43, the vehicle D2 or D3 sets the parking-lot caution zone 45c for the surrounding vehicle 43. As shown in FIG. 14, the front vehicle D2 or the following vehicle D3 sets the parking-lot caution zone 45c for the parking vehicle D1 since there is a parking spot near the parking vehicle D1.

Then, the path selection unit 285 selects a driving plan so that the parking-lot caution zone 45c for the parking vehicle D1 and the subject-vehicle caution zone 45a do not overlap with each other. If the parking-lot caution zone 45c for the parking vehicle D1 and the subject-vehicle caution zone 45a overlap with each other, the path selection unit 285 selects a driving plan to eliminate the overlapping or the subject vehicle 40 stops to avoid overlapping between the safety distance 42 for the subject vehicle 40 and the parking-lot caution zone 45c for the parking vehicle.

As described above, according to the path checking unit 28 in the present embodiment, when a moving obstacle 46 exists around the subject vehicle 40, the caution zone setting unit 286 sets the caution zone 45 at a position away from the subject vehicle beyond the safety distance 42 and is located between the moving obstacle 46 and the subject vehicle 40. Then, the path selection unit 285 selects, from among the generated driving plans, a driving plan along which the subject vehicle 40 will travel such that the moving obstacle 46 does not come in the set caution zone 45. By setting the caution zone 45, it is possible to prevent the subject vehicle 40 from approaching the moving obstacle 46 within the safety distance 42, thereby suppressing occurrence of the deadlock.

Further, if the moving obstacle 46 enters the set caution zone 45, the emergency stop unit 282 controls the travel control ECU 31 to execute at least one of deceleration control and steering control for the subject vehicle 40 so as to increase the distance to the moving obstacle 46. If the distance between the subject vehicle 40 and the obstacle is reduced to be smaller than the safety distance 42, the subject vehicle 40 stops urgently. However, when the moving obstacle 46 enters the caution zone 45, the subject vehicle 40 does not stop urgently and performs at least one of the deceleration control and the steering control to increase the distance. Therefore, the distance to the moving obstacle 46 can be expanded without making an emergency stop, and thus the subject vehicle 40 can continue to travel.

For example, a comparative example using the safe distance 42 and an exclusive area instead of using the caution zone 45 of the present embodiment will be described. The exclusive area is defined as a fixed area that is set in advance in a parking lot or the like, and is an area in which only one vehicle can be parked in the exclusive area. A plurality of exclusive areas are set, for example, on a travel path in a parking lot. A plurality of exclusive areas are set, and since only one vehicle can enter each exclusive area, the vehicle-to-vehicle distances 44 are secured between the vehicles. Assuming that a surrounding vehicle 43 stops to wait near the exclusive area when the subject vehicle 40 is traveling on the travel path 52 to park in the exclusive area. In other words, since only one vehicle can enter the exclusive area, the surrounding vehicle 43 needs to temporally stop at a location outside of the exclusive area when the vehicle 40 is taking parking action. In this case, the subject vehicle 40 may enter an area within the safety distance 42 of the surrounding vehicle 43 that is close to the exclusive area. This is because the surrounding vehicle 43 that is close to the exclusion area may have the safety distance 42 come in the exclusion area. As a result, either the subject vehicle 40 or the surrounding vehicle 43 have to be backed up, and if there is another vehicle behind the surrounding vehicle 43, the surrounding vehicle 43 may not be able to be backed up, resulting in the deadlock. Therefore, the comparative example using the exclusive areas cannot avoid occurrence of the deadlock.

Furthermore, another comparative example where the safety distance 42 is expanded, instead of using the caution zone 45 of the present embodiment, will be described. If the safety distance 42 is expanded up to the subject-vehicle caution zone 45a or the parking-lot caution zone 45c, for example, the subject vehicle 40 would take an emergency avoidance action when the vehicle-to-vehicle distance 44 between the subject vehicle 40 and the surrounding vehicle 43 decreases to be equal to or less than the safety distance 42. If the safety distance 42 is expanded, there is a high possibility that the vehicle-to-vehicle distance decreases to be less than the safety distance 42 due to sudden stop by a preceding vehicle. Thus, the emergency avoidance action may occur very often. In addition, if the safety distance 42 for the subject vehicle 40 is expanded for parking, the vehicle-to-vehicle distance 44 between the subject vehicle 40 and the surrounding vehicle 43 may decrease to be less than the safety distance 42. Therefore, occurrence of the deadlock is likely to increase.

In this way, even if the exclusive area is used or the safety distance 42 is extended, the deadlock and emergency avoidance may occur frequently as compared to the present embodiment. In contrast, by setting the caution zone 45 as in the present embodiment, it is possible to flexibly secure the distance to the moving obstacle 46 while stopping and parking the subject vehicle 40 . In particular, since the caution zone 45 is set in front of the subject vehicle in the travel direction, it is possible to prevent the subject vehicle 40 from approaching, in the travel direction, a moving obstacle 46 such as a surrounding vehicle 43. Therefore, when the traveling direction is a forward direction and the subject vehicle 40 stops during traveling in the forward direction to take a parking action, the front space of the subject vehicle 40 is secured due to the caution zone 45 even if a following vehicle is so close to the subject vehicle 40 as to prevent the subject vehicle 40 from going rearward. Therefore, it is possible to prevent occurrence of the deadlock in which neither forward movement nor backward movement is allowed.

In the present embodiment, the caution zone setting unit 286 sets the moving-obstacle caution zone 45b around the moving obstacle 46. The moving-obstacle caution zone 45b is separately set from the subject-vehicle caution zone 45a. Then, the path selection unit 285 selects, among from the generated driving plans, a driving plan such that the subject vehicle travels without overlapping between the set subject-vehicle caution zone 45a and the moving-obstacle caution zone 45b. As a result, the distance to the moving obstacle 46 can be further expanded.

In the present embodiment, if the set subject-vehicle caution zone 45a and the moving-obstacle caution zone 45b overlap with each other, the path selection unit 285 selects a driving plan where the distance between the subject vehicle and the moving obstacle 46 is maintained to be equal to or greater than the safety distance 42 to eliminate the overlap between the caution zones 45. For example, when the subject vehicle 40 attempts to keep a distance to a moving obstacle 46, the moving obstacle 46 may stop, move backward, or turn around for parking. In this case, the subject-vehicle caution zone 45a and the moving-obstacle caution zone 45b may overlap with each other, but since the caution zone 45 is set in anticipation of such behavior of the moving obstacle in advance, the path selection unit 285 selects a driving plan to eliminate overlapping without taking the emergency avoidance action. As a result, the distance to the moving obstacle 46 can be secured.

Furthermore, in the present embodiment, when the subject vehicle 40 is traveling to be parked in a parking space 51, the caution zone setting unit 286 sets the parking-lot caution zone 45c that includes a travel path 52 from the current position of the subject vehicle 40 to the parking space 51. The parking-lot caution zone 45c is separately set from the subject-vehicle caution zone. 45a. Then, the path selection unit 285 selects, among from the generated driving plans, a driving plan along which the subject vehicle will travel without overlapping between the set parking-lot caution zone 45c and the moving-obstacle caution zone 45b. As a result, when the vehicle 40 is taking a parking action, it is possible to prevent the vehicle 40 from closely approaching the moving obstacle 46, thereby preventing deadlock.

Furthermore, in the present embodiment, when the subject vehicle 40 is traveling in a parking lot and the moving obstacle 46 is a surrounding vehicle 43 that is traveling around the subject vehicle 40, the caution zone setting unit 286 sets the parking-lot caution zone 45c that includes a travel path 52 from the current position of the surrounding vehicle 43 to the parking space 51 in anticipation of parking in the parking space 51 by the surrounding vehicle 43. The parking-lot caution zone 45c is separately set from the subject-vehicle caution zone. 45a. Then, the path selection unit 285 selects, from among the generated driving plans, a driving plan along which the set subject-vehicle caution zone 45a and the parking-lot caution zone 45c will not overlap with each other. If there is not such a driving plan, the path selection unit 285 controls the travel control ECU 31 to stop the subject vehicle 40. As a result, when the surrounding vehicle 43 is traveling to be parked, it is possible to secure a space for the surrounding vehicle 43 to park and prioritize the parking by the surrounding vehicle 43.

Furthermore, in the present embodiment, the caution distance setting unit 284 sets the caution distance 41 as a distance to be kept between the subject vehicle and the surrounding vehicle 43. The caution distance 41 is a distance greater than the safety distance 42. Then, the emergency stop unit 282 controls the travel control ECU 31 to decelerate the subject vehicle when the subject vehicle cannot travel with the caution distance 41 such that the vehicle-to-vehicle distance 44 between the subject vehicle 40 and the surrounding vehicle 43 increases to be equal to or greater than the caution distance 41. Accordingly, if the vehicle-to-vehicle distance 44 between the subject vehicle and the surrounding vehicle 43 decreases to be less than the caution distance 41, the subject vehicle is decelerated to expand the vehicle-to-vehicle distance 44 without making an emergency stop. Therefore, even if the surrounding vehicle 43 repeats acceleration and deceleration due to unstable traveling state, for example, and even if the caution distance 41 is temporarily invaded, the vehicle-to-vehicle distance 41 can be expanded to be greater than the caution distance 41 by decelerating the subject vehicle without making an emergency stop. Therefore, it is possible to avoid making an unnecessary emergency stop.

In the present embodiment, if a moving obstacle 46 exists, the caution zone setting unit 286 sets the caution zone 45 at a position that is away from the subject vehicle 40 beyond the caution distance 41 and is located between the moving obstacle 46 and the subject vehicle 40 in a traveling direction. As a result, the distance to the moving obstacle 46 can be further expanded when the moving obstacle 46 exists.

In other words, if the safety distance 42 uses only geometric information, it would cause deadlock in a parking lot that requires complicated situation determination. Therefore, by adding a rule limitedly used in the situation of a parking lot, it is possible not only to reduce the possibility of falling into deadlock, but also to prevent accidents caused by sudden actions taken by surrounding vehicles 43.

Therefore, in the present embodiment, as described above, the caution zones 45 including the safety distance 42 are set in a place such as a parking lot where the driving conditions of the subject vehicle and other vehicles are likely to change, and the driving plan is evaluated in consideration of the caution zones 45 of the subject vehicle and the other vehicles. In a situation such as a parking lot where a preceding vehicle or an oncoming vehicle may suddenly stop or reverse, the safety distance 42 alone considering the driving state may be insufficient. That is, in a parking lot or the like, the safety distance 42 tends to be short because the vehicle is traveling at a low speed, and there is a high possibility that the vehicle will be too close to a preceding vehicle and cause the deadlock. In addition, since the vehicle travels at a low speed, the safety distance 42 is short, and there is a high risk of occurrence of deadlock due to another vehicle entering into a planned path to a target parking position. Thus, there is a high possibility that the subject vehicle 40 interferes with parking of the oncoming vehicle.

In view of the above, in the present embodiment, by assuming that a preceding vehicle is parked in reverse, the subject-vehicle caution zone 45a is additionally set in addition to the safety distance 42. Also, when a target parking space for the subject vehicle 40 is found, the parking-lot caution zone 45c is set to include the switching area and the parking space, and if another vehicle enters the area 45c, the subject vehicle stops. Furthermore, when a parking space and an oncoming vehicle are found, the parking-lot caution zone 45c for the oncoming vehicle is calculated, and a driving plan that would not cause the subject vehicle 40 to enter the calculated caution zone 45c is selected. Accordingly, it is possible to reduce the possibility that deadlock occurs.

### Second Embodiment

As described in [When the subject vehicle 40 is a parking vehicle D1] in the first embodiment, the parking vehicle D1, which is the subject vehicle 40, may set the parking-lot caution zone 45c. Furthermore, in [When the subject vehicle 40 is a front vehicle D2 or a following vehicle D3] in the first embodiment, the front vehicle D2 may set the parking-lot caution zone 45c for the parking vehicle D1. The front vehicle D2 prevents the parking-lot caution zone 45c set for the parking vehicle D1 from overlapping with the moving-obstacle caution zone 45b for the front vehicle D2.

Assuming that the parking-lot caution zone 45c and the moving-obstacle caution zone 45b have the relationship shown in FIG. 14, the front vehicle D2 is waiting for its turn as described in the first embodiment. When the parking vehicle D1 ends parking, setting of the parking-lot caution zone 45c is canceled. Therefore, the front vehicle D2 waits until then.

Furthermore, in [When the subject vehicle 40 is a front vehicle D2 or a following vehicle D3] in the first embodiment, the front vehicle D2 may set the parking-lot caution zone 45c for the parking vehicle D1 if there is a parking spot near the parking vehicle D1. That is, each of the parking vehicle D1 and the front vehicle D2 can separately set the parking-lot caution zone 45c for the parking vehicle D1. Therefore, in order for the front vehicle D2 to wait for its turn to prevent occurrence of deadlock, it is not essential for the parking vehicle D1 to recognize that the front vehicle D2 sets the parking-lot caution zone 45c for the parking vehicle D1.

However, it is not preferable for the parking vehicle D1 to travel without knowing whether the front vehicle D2 has set the parking-lot caution zone 45c for the parking vehicle D1. That is, in order to effectively prevent occurrence of deadlock, it is preferable for the parking vehicle D1 to recognize that the front vehicle D2 sets the parking-lot caution zone 45c for the parking vehicle D1.

In view of the above, in the second embodiment, when the parking-lot caution zone 45c is set for the parking vehicle D1, it is determined whether the front vehicle D2 sets the parking-lot caution zone 45c for the parking vehicle D1.

In order for the parking vehicle D1 to recognize that the front vehicle D2 has set the parking-lot caution zone 45c for the parking vehicle D1, it is conceivable that the parking vehicle D1 and the front vehicle D2 wirelessly communicate with each other. Wireless communication includes vehicle-to-vehicle communication and vehicle-to-roadside multiple communication. However, the parking vehicle D1 and the front vehicle D2 may not be able to communicate wirelessly.

Therefore, when the parking vehicle D1 cannot wirelessly communicate with the front vehicle D2, it is determined from the behavior of the front vehicle D2 whether the front vehicle D2 has set the parking-lot caution zone 45c for the parking vehicle D1.

FIG. 15 shows processing executed when the caution zone mode is set in the second embodiment. In FIG. 15, S31 and S32 are the same as those explained in FIG. 12.

In the second embodiment, after executing S32, the path selection unit 285 executes S33 and subsequent steps. At S33, it is determined whether communication with the front vehicle D2 is possible. When the determination result of S33 is YES, the process proceeds to S34.

At S34, the parking vehicle D1, which is the subject vehicle 40, notifies, via wireless communication, the front vehicle D2 that the parking vehicle D1 has set the parking-lot caution zone 45c for the subject vehicle 40 (i.e., the parking vehicle D1). When the front vehicle D2 receives the notification, the front vehicle D2 sets the parking-lot caution zone 45c for the parking vehicle D1 if the area 45c is not set for the parking vehicle D1. Thereafter, the front vehicle D2 notifies the parking vehicle D1 that the parking-lot caution zone 45c has been set for the parking vehicle D1. If the front vehicle D2 having received the notification from the parking vehicle D1 has already set the parking-lot caution zone 45c for the parking vehicle D1, the front vehicle D2 notifies the parking vehicle D1 that the parking-lot caution zone 45c has been already set.

At S35, the path selection unit 285 of the subject vehicle 40 selects a driving plan that causes the subject vehicle 40 to travel along the travel path 52 included in the parking-lot caution zone 45c at S35 and outputs an instruction to the automated-driving function unit 29 to control the subject vehicle 40 to travel to the parking space 51.

Next, the description when the determination result of S33 is “NO” will be described. If the determination result at S33 is “NO”, the process proceeds to S36. At S36, it is determined whether the caution zones 45 overlap with each other. It should be noted that “the caution zones 45 overlap” includes not only the case of already overlapping, but also the case of overlapping in future. The case of overlapping in future includes, for example, the case where the two caution zones 45 will overlap with each other in a few seconds and the case where the two caution zones 45 will overlap with each other during traveling of the subject vehicle 40 along the travel path 52 . FIG. 14 shows a situation where it is determined that the parking-lot caution zone 45c and the moving-obstacle caution zone 45b overlap with each other.

When the determination result of S36 is NO, the step at S35 is executed. When the determination result of S36 is YES, the step at S37 is executed. The step at S37 is a confirmation process. At the confirmation process, the parking vehicle D1 confirms whether the front vehicle D2 has set the parking-lot caution zone 45c for the parking vehicle D1. If the front vehicle D2 has set the parking-lot caution zone 45c for the parking vehicle D1, the front vehicle D2 should travel without entering into the parking-lot caution zone 45c. Therefore, the confirmation process can also be said to be a process of confirming whether the front vehicle D2 moves so as not to enter the parking-lot caution zone 45c.

Specifically, at the confirmation process shown in FIG. 15, S372, S373, and S374 are executed. At S372, the subject vehicle travels forward by a small distance. The forward traveling distance is the shortest possible distance based on which the front vehicle D2 can clearly recognize that the subject vehicle 40 has moved. The forward traveling distance may be obtained by calculation within a range where the subject-vehicle caution zone 45a does not overlap with the moving-obstacle caution zone 45b. Also, the forward traveling distance (for example, several meters) may be stored in advance.

At S373, it is determined whether the front vehicle D2 is waiting for its turn. When the subject vehicle 40 moves a little, if the front vehicle D2 is stopped or is slowing down to stop so that the caution zones 45 do not overlap with each other, the front vehicle D2 is determined to wait for its turn. When the determination result of S373 is YES, the step at S35 is executed.

If the determination result of S373 is NO, the process proceeds to S374. When proceeding to S374, the front vehicle D2 can be determined not to set the parking-lot caution zone 45c for the parking vehicle D1. Therefore, at S374, a driving plan to wait (that is, a driving plan to stop) is selected until the overlapping of the caution zones 45 is eliminated. Then, after the overlapping of the caution zones 45 is eliminated, S35 is executed.

By doing so, the driving plan for the vehicle 40 to park in the parking space 51 can be made more appropriate.

### Third Embodiment

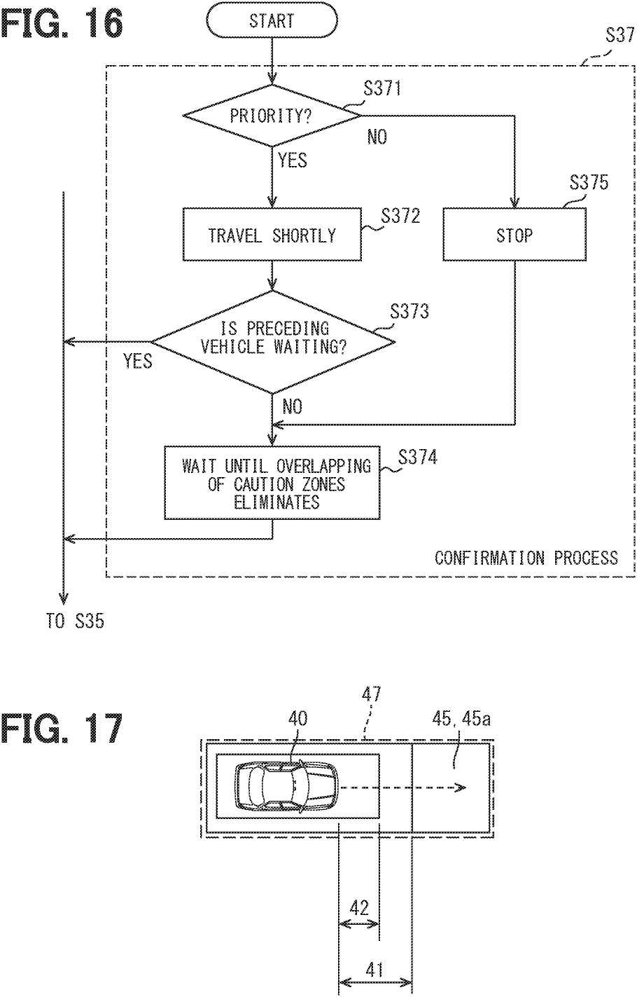

In the third embodiment, instead of the confirmation process shown in FIG. 15, the confirmation process shown in FIG. 16 is executed. The confirmation process shown in FIG. 16 includes steps of S371 and S375 in addition to the confirmation process shown in FIG. 15.

At S371, it is determined whether the subject vehicle has a priority to move. Whether the subject vehicle 40 is prioritized to move is determined based on a predetermined determination condition. An example of this condition is distance. Alternatively, the determination condition may be a condition that the subject vehicle 40 is closer to the parking space 51 than other vehicles. Furthermore, the determination condition may be a time expected to be required for the subject vehicle 40 to park in the parking space 51 (hereinafter, referred to as “expected parking time”). This is because if the subject vehicle can be parked in the parking space 51 in a relatively short time, the subject vehicle 40 can be determined to have a priority to move. Specifically, when the expected parking time is shorter than a predetermined priority upper limit time, it is determined that the subject vehicle 40 is prioritized to move.

Another example of the determination condition is the complexity of the travel path 52 . If there are many turns required during traveling along the travel path 52, the time required for the subject vehicle 40 to park in the parking space 51 tends to be long. Therefore, the complexity of the travel path 52 correlates with the expected parking time. The complexity of the travel path 52 is quantified based on the number of turns, etc., and if the quantified value of the complexity is equal to or less than a threshold value, it is determined that the subject vehicle 40 has a priority to move.

Other examples of the determination condition are the speed, acceleration, and jerk of the front vehicle D2. This is because, if these are higher than each of predetermined thresholds, it can be considered that there is a high possibility that the front vehicle D2 does not wait for its turn.

When the determination result of S371 is YES, the steps at S372 to S374 as described in the second embodiment are executed. If the determination result of S371 is NO, the process proceeds to S375. When proceeding to S375, the front vehicle D2 has a priority and there is a high possibility that the front vehicle D2 does not stop. Therefore, at S375, the subject vehicle 40 is stopped. Alternatively, if the subject vehicle 40 has already stopped, the stopped state is maintained. Thereafter, the process proceeds to S374, and the stopped state is continued until overlapping between the caution zones 45 is eliminated.

According to the third embodiment, when the caution zones 45 overlap with each other (S36: YES) and there is a high possibility that the front vehicle D2 will not stop (S371: NO), the parking vehicle D1 quickly stops. Therefore, overlapping between the caution zones 45 can be eliminated quickly.

### Fourth Embodiment

In the second embodiment, when the determination result at S36 is YES, the subject vehicle 40 is caused to travel forward shortly. However, the subject vehicle 40 may be stopped when the determination result of S36 is YES.

### Fifth Embodiment

In the first embodiment, the emergency stop unit 282 is described as an example of the emergency control unit. The emergency stop unit 282 controls the subject vehicle 40 to make an emergency stop when the safety distance 42 cannot be secured during traveling.

If the vehicle cannot travel with the safety distance 42, the driving plan that causes the subject vehicle 40 to continue to travel cannot be selected. Therefore, in preparation for the situation where it is not possible for the subject vehicle to travel while ensuring the safety distance 42, emergency control may be prepared in addition to the control according to the driving plan. Such emergency control may be a control other than the control which causes the subject vehicle 40 to stop urgently. For example, if the safety distance 42 can be ensured by changing the lane without following the driving plan, the control for changing lanes can be used as the control in an emergency situation. Also, the emergency control may be a control for sounding a horn. This is because, first, by sounding the horn, behavior of the surrounding vehicle 43 changes, and then there is a possibility that the safety distance 42 can be secured because of the behavior change of the surrounding vehicle 43 .

### Sixth Embodiment

In the above-described embodiments, the parking-lot caution zone 45c is set when the subject vehicle 40 or the surrounding vehicle 43 is taking a parking action into the parking space 51 of the parking lot. However, the parking-lot caution zone 45c may be also set when it can be expected that the subject vehicle 40 or the surrounding vehicle 43 will park in a parking space 51 formed at a roadside other than a parking lot.

Further, the parking-lot caution zone 45c may be also set if it can be expected that the subject vehicle 40 or the surrounding vehicle 43 will park in a space for parking other than the parking space defined by lines. Areas without lines defining the parking space may include vacant parking spots without lines, areas where parking is expected when a vehicle arrives a destination (e.g., station).

### Seventh Embodiment

In the example shown in FIG. 7 , the caution zone 45 is away from the subject vehicle 40 over the caution distance 41 that is greater than the safety distance 42 . However, the caution zone 45 may be set at a position away from the subject vehicle 40 over the safety distance 42 that is shorter than the caution distance 41 .

### Eighth Embodiment

A safety area 47 may be set in front of the subject vehicle 40 in the traveling direction as an area including the safety distance 42 and the caution zone 45 . The safety area 47 may be an area including the caution distance 41 and the caution zone 45 using the caution distance 41 instead of using the safety distance 42 . The safety area 47 shown in FIG. 17 is an area including the caution distance 41 and the caution zone 45 therein. In addition, a safety envelope may be set as a concept corresponding to at least one of the above-described safety distance 42, caution distance 41, caution zone 45, and safety distance 47, or as a concept collectively including at least two of the safety distance 42, caution distance 41, caution zone 45, and safety distance 47. The definition of the “safety envelope” may be a common concept that can be used to address all the principles that the driving policy might comply with. According to this concept, the autonomous vehicle (AV) might have one or more boundaries around the vehicle, where the violation of one or more of these boundaries result in different responses by the AV. The safety envelope may be a set of limits and conditions under which the system is designed to maneuver, subject to controls to maintain maneuvering at an acceptable level of risk.

### Other Embodiments

The present disclosure is not limited to the preferred embodiments of the present disclosure described above. Various modifications may be made without departing from the subject matters of the present disclosure.

It should be understood that the configurations described in the above-described embodiments are example configurations, and the present disclosure is not limited to the foregoing descriptions. The scope of the present disclosure encompasses claims and various modifications of claims within equivalents thereof.

In the above-described embodiments, the path checking device is implemented as the path checking unit 28, which is one of the functional blocks of the automated-driving unit 26, but the configuration is not limited to this. The path checking device may be realized by a control device different from the automated-driving unit 26.

In the embodiments described above, the default of the safety distance 42 is calculated by a mathematical formula model, but the configuration is not necessarily limited to this. For example, the default of the safety distance 42 may be calculated by a method other than the mathematical model. For example, the safety distance setting unit 281 may be configured to calculate the safety distance 42 using information on the behavior of the subject vehicle 40 and a moving body around the subject vehicle 40 based on another index such as TTC (Time To Collision).

In the above-described embodiments, a parking lot is taken as an example of a place of not-normal traveling, but the place of not-normal traveling is not limited to a parking lot. For example, such a place may be a site where slow driving or low-speed driving is compulsory. For example, places with many moving obstacles 46, such as places with many people such as markets and shopping streets, inside amusement parks, inside airports, etc., may be processed in the same way as parking lots. Also, although the caution distance 41 is set in the first embodiment, the caution distance 41 may not be set.

In the above-described embodiments, the functions realized by the vehicle control unit 21 may be realized by hardware and software different from those described above or by a combination of the hardware and the software. The vehicle control unit 21 may communicate with, for example, another control device, and the other control device may execute a part or all of the process. When the vehicle control unit 21 is realized by an electronic circuit, the output controller 30 may be realized by a digital circuit or an analog circuit, including a large number of logic circuits.

1. A path checking device for a subject vehicle including a path generation unit that generates a plurality of driving plans for the subject vehicle to travel by automated-driving and a travel control unit that controls traveling of the subject vehicle according to one of the driving plans, the path checking device comprising:
a safety distance setting unit that is configured to set a minimum safety distance for the subject vehicle to an obstacle in order for the subject vehicle to avoid closely approaching the obstacle;
an emergency control unit that is configured to:
determine whether the subject vehicle is traveling with the safety distance; and
execute emergency control for the subject vehicle that is different from normal control according to one of the driving plans when a distance between the subject vehicle and the obstacle is less than the safety distance;
a caution zone setting unit that is configured to, when a moving obstacle is located ahead of the subject vehicle, set a caution zone for the subject vehicle that is located away from the subject vehicle over the safety distance and is between the moving obstacle and the subject vehicle; and
a path selection unit that is configured to select, from among the generated driving plans, a driving plan along which the subject vehicle will travel such that the moving obstacle does not come in the caution zone for the subject vehicle.

2. The path checking device according to claim 1, wherein
if the moving obstacle enters the caution zone, the emergency control unit is further configured to control the travel control unit to execute at least one of deceleration control and steering control to increase the distance to the moving obstacle.

3. The path checking device according to claim 1, wherein
the caution zone setting unit is further configured to set, in addition to the caution zone for the subject vehicle, a moving-obstacle caution zone for the moving obstacle around the moving obstacle, and
the path selection unit is further configured to select, from among the generated driving plans, a driving plan along which the subject vehicle will travel such that the caution zone for the subject vehicle and the moving-obstacle caution zone do not overlap with each other.

4. The path checking device according to claim 3, wherein
if the caution zone for the subject vehicle and the moving-obstacle caution zone overlap with each other during traveling of the subject vehicle, the path selection unit is further configured to select a driving plan along which the subject vehicle will travel such that the distance to the moving obstacle is maintained beyond the safety distance and the overlap between the caution zone for the subject vehicle and the moving-obstacle caution zone is eliminated.

5. The path checking device according to claim 3, wherein
when the subject vehicle is traveling to park in a parking area, the caution zone setting unit is further configured to set, in addition to the caution zone for the subject vehicle, a parking-lot caution zone for the subject vehicle that includes a travel path from a current position of the subject vehicle to the parking area, and
the path selection unit is further configured to select, from among the generated driving plans, a driving plan along which the subject vehicle will travel such that the parking-lot caution zone for the subject vehicle and the moving-obstacle caution zone do not overlap with each other.

6. The path checking device according to claim 1, wherein
when the moving obstacle is a surrounding vehicle that is traveling around the subject vehicle and the surrounding vehicle is expected to park in a parking area, the caution zone setting unit is further configured to set, in addition to the caution zone for the subject vehicle, a parking-lot caution zone for the surrounding vehicle that includes a travel path from a current position of the surrounding vehicle to the parking area, and
the path selection unit is further configured to select, from among the generated driving plans, a driving plan along which the subject vehicle will travel such that the caution zone for the subject vehicle and the parking-lot caution zone for the surrounding vehicle do not overlap with each other.

7. The path checking device according to claim 6, wherein
if there is no driving plan, among the generated driving plans, along which the subject vehicle would travel such that the caution zone for the subject vehicle and the parking-lot caution zone for the surrounding vehicle do not overlap with each other, the path selection unit is further configured to control the travel control unit to stop the subject vehicle.

8. The path checking device according to claim 1, further comprising
a caution distance setting unit that is configured to set a caution distance that is greater than the safety distance as a distance to be kept between the subject vehicle and the moving obstacle, and
the emergency control unit is further configured to:
determine whether the subject vehicle is traveling with the caution distance; and
control the travel control unit to increase the distance to the moving obstacle to exceed the caution distance when the distance to the moving obstacle is less than the caution distance, and
when the moving obstacle exists, the caution zone setting unit is further configured to set the caution zone that is an area located away from the subject vehicle over the caution distance and is between the subject vehicle and the moving obstacle.

9. A path checking device for a subject vehicle including a path generation unit that generates a plurality of driving plans for the subject vehicle to travel by automated-driving and a travel control unit that controls traveling of the subject vehicle according to one of the driving plans, the path checking device comprising:
a safety distance setting unit that is configured to set a minimum safety distance for the subject vehicle to an obstacle in order for the subject vehicle to avoid closely approaching the obstacle;
an emergency control unit that is configured to:
determine whether the subject vehicle is traveling with the safety distance; and
execute emergency control for the subject vehicle that is different from normal control according to one of the driving plans when a distance between the subject vehicle and the obstacle is less than the safety distance;
a caution zone setting unit that is configured to:
set a parking-lot caution zone for the subject vehicle that includes a travel path from a current position of the subject vehicle to a parking area when the subject vehicle is traveling to park in the parking area; and
set a moving-obstacle caution zone for a moving obstacle around the moving obstacle when the moving obstacle is located ahead of the subject vehicle; and
a path selection unit that is configured to select a driving plan along which the subject vehicle will travel to park in the parking area when the parking-lot caution zone for the subject vehicle and the moving-obstacle caution zone for the moving obstacle do not overlap with each other.

10. The path checking device according to claim 9, wherein
the path selection unit is further configured to, when the parking-lot caution zone for the subject vehicle and the moving-obstacle caution zone for the moving obstacle overlap with each other:
execute a confirmation process to confirm whether the moving obstacle will travel without entering the parking-lot caution zone set by the subject vehicle; and then
select a driving plan along which the subject vehicle will travel to park in the parking area.

11. The path checking device according to claim 10, wherein
the confirmation process includes a process to determine, based on a behavior by the moving obstacle when the subject vehicle stops or travels for a short distance, whether the moving obstacle is waiting until the subject vehicle terminates parking process.

12. The path checking device according to claim 11, wherein
the confirmation process includes a process to determine whether the moving obstacle is waiting until the subject vehicle terminates the parking process by:
controlling the subject vehicle to travel for a short distance when the subject vehicle is determined to be prioritized to move; and
controlling the subject vehicle to stop when the moving obstacle is determined to be prioritized to move.

13. A path checking method executed by a processor used in a subject vehicle that travels according to one of a plurality of driving plans by automated-driving, the method comprising:
setting a minimum safety distance for the subject vehicle to an obstacle in order for the subject vehicle to avoid closely approaching the obstacle;
determining whether the subject vehicle is traveling with the safety distance; executing emergency control for the subject vehicle that is different from normal control according to one of the driving plans when a distance from the subject vehicle to the obstacle is less than the safety distance;
when a moving obstacle is located ahead of the subject vehicle, setting a caution zone for the subject vehicle that is located away from the subject vehicle over the safety distance and is between the moving obstacle and the subject vehicle; and
selecting, from among the generated driving plans, a driving plan along which the subject vehicle will travel such that the moving obstacle does not come in the caution zone for the subject vehicle.

14. A path checking method executed by a processor used in a subject vehicle that travels according to a driving plan by automated-driving, the method comprising:
setting a minimum safety distance for the subject vehicle to an obstacle in order for the subject vehicle to avoid closely approaching the obstacle;
determining whether the subject vehicle is traveling with the safety distance; executing emergency control for the subject vehicle that is different from normal control according to the driving plan when a distance from the subject vehicle to the obstacle is less than the safety distance;
setting a parking-lot caution zone for the subject vehicle that includes a travel path from a current position of the subject vehicle to a parking area when the subject vehicle is traveling to park in the parking area;
setting a moving-obstacle caution zone for a moving obstacle around the moving obstacle when the moving obstacle is located ahead of the subject vehicle; and
selecting a driving plan along which the subject vehicle will travel to park in the parking area when the parking-lot caution zone for the subject vehicle and the moving-obstacle caution zone for the moving obstacle do not overlap with each other.
